(19) United States
(12) Patent Application Publication
(10) Pub. No.: US 2006/0045601 A1
(43) Pub. Date: Mar. 2, 2006

(54) Printing apparatus and printing method

(75) Inventor: Hironori Endo, Nagano-ken (JP)

Correspondence Address: SUGHRUE MION, PLLC, 2100 PENNSYLVANIA AVENUE, N.W., SUITE 800, WASHINGTON, DC, 20037, US

(73) Assignee: SEIKO EPSON CORPORATION

(21) Appl. No.: 11/210,782

(22) Filed: Aug. 25, 2005

(30) Foreign Application Priority Data
Aug. 25, 2004 (JP) 2004-245443
Aug. 25, 2004 (JP) 2004-245444
Aug. 25, 2004 (JP) 2004-245445

(51) Int. Cl. B41J 13/14

(52) U.S. Cl. 400/642

(57) ABSTRACT

An object is to acquire the precise width dimension of a medium that is loaded into a paper feed section of a printing apparatus and that has a size other than the standard sizes. The printing apparatus includes *a paper feed section into which media are loaded, a regulating guide provided movably for regulating positional shifting of the media in close proximity to the edge of the loaded media, and a position sensor capable of detecting any given position of the regulating guide. Further, in order to detect the position of the regulating guide, as the position sensor, there are provided: a position detection pattern provided on the paper feed section side, an optical sensor that is provided on the regulating guide side, that has a light-emitting section emitting light toward the position detection pattern and a light-receiving section receiving light reflected from the position detection pattern, and that outputs a signal corresponding to the intensity of the light received by the light-receiving section, and a detection section for detecting the position of the regulating guide based on the signal outputted from the optical sensor. In addition, there is provided a sensor for detecting the presence of media within a predetermined distance from the regulating guide.

### CROSS-REFERENCE TO RELATED APPLICATIONS

The present Application claims priority upon Japanese Patent Application No. 2004-245443, Japanese Patent Application No. 2004-245444, and Japanese Patent Application No. 2004-245445 filed on Aug. 25, 2004, which are incorporated herein by reference

### BACKGROUND OF THE INVENTION

1. Field of the Invention

The present invention relates to printing apparatuses and printing methods.

2. Description of the Related Art

<Part 1 >

Various types of printing apparatus, primarily inkjet printers and the like, print on a variety of different media, including plain paper, photographic paper, matte paper, film, post cards, etc. In addition, these media have a variety of different sizes. There are various sizes such as “A4”, “H5”, “A5”, “post card”, “letter”, etc. During printing, the type and size of media loaded in the paper feed section of a printing apparatus are set by users. However, significant differences between the type and size of media set by users and the type and size of the media actually loaded into the paper feed section may result in problems, such as images that do not precisely fit on the media, deterioration in image quality, etc.

Accordingly, in various types of printing apparatus, media to be printed are checked for size. The following techniques are employed for checking the size of media to be printed upon.

(1) When media are fed during printing, the lateral width of the media is detected with the help of an optical sensor etc. provided, for instance, in a head, which ejects ink while moving relative to the media (see JP 2004-74706A or JP 2002-103721A).

(2) The sizes of the media are checked by reading a mechanical switch indicating standard media sizes and provided on a paper feed cassette etc., that is, for instance, a switch indicating various standard sizes such as size “A4”, size “B4”, “post card”, etc.

Such methods, however, are associated with the following problems. Namely, in case of (1), it is impossible to check the sizes of the media until the media are actually fed from the paper feed section during printing.

In addition, although in case of (2) it is possible to check the sizes of the media prior to printing, however, only standard sizes could be checked, such as size “A4”, size “B4”, “post card”, etc. For this reason, no size checking is done for sizes other than the standard ones. As a result, when printing is performed on media of sizes other than the standard ones, it is extremely difficult to precisely identify the size of the media.

In addition, although in case of (2) it is possible to determine the size of the media prior to printing, the use of a mechanical switch for checking the size of the media causes degradation of the mechanical switch due to wear and tear in mechanical contact portions, fatigue and changes in parts over time, etc., thereby making it extremely difficult to perform checking in a highly accurate manner over an extended period of time.

<Part 2 >

In various types of printing apparatus, including inkjet printers and the like, a regulating guide used to regulate the positional shifting of media to be printed is provided on the paper feed section. Into this paper feed section, plain paper, photographic paper, matte paper, film, post-cards, and various other media are loaded. The regulating guide is provided in close proximity to the edge of the media and regulates the positional shifting of the media in the width direction. Thus, during printing, the media can be smoothly carried to the printing section.

Incidentally, the media to be printed on may have various sizes, mainly size “A4”, size “B5”, the post-card size, as well as envelopes, business cards, etc. In order to accommodate such media of various sizes, the regulating guide is typically provided in a movable fashion (see JP 2001-278458A and JP 2001-335160A). Providing the regulating guide in a movable fashion in this manner makes it possible to accommodate media of various sizes, such as size “A4”, size “B5”, the post-card size, etc. As a result, media of any size can be smoothly carried to the printing section during printing.

However, printing apparatus provided with such a movable regulating guide has the following problems. Namely, printing is occasionally performed without the regulating guide being set at the correct position corresponding to the size of the media. This is due to the fact that the setting of the regulating guide is done by users, and sometimes, despite changes in the size of the print media, the users does not move the regulating guide to the appropriate position corresponding to the size of the print media.

Failure to set the regulating guide at the appropriate position corresponding to the size of the media may make it impossible to sufficiently regulate the positional shifting of the media. As a result, problems arise, such as failure to sufficiently regulate the positional shifting of the media and failure to carry the media smoothly during printing.

### SUMMARY OF THE INVENTION

The present invention was made with account taken of the above circumstances, and its object is, firstly, to enable accurate estimation of the width dimensions of media even when media having sizes other than the standard ones are loaded into the paper feed section. In addition, secondly, it is to enable highly accurate detection of the size of the media loaded into the paper feed section over an extended period of time. Also, thirdly, it is to enable confirmation of whether or not the positional shifting of the media can be sufficiently regulated by the regulating guide.

A primary aspect of the present invention consists in the following printing apparatus.

A printing apparatus includes:

a paper feed section into which a medium to be printed is loaded;

a regulating guide provided movably relative to the paper feed section for regulating positional shifting of the medium in close proximity to an edge of the medium loaded into the paper feed section; and

a position sensor capable of detecting any given position of the regulating guide with respect to the paper feed section.

Further, another primary aspect of the present invention consists in the following printing method.

A printing method includes;

a step of detecting, using a position sensor, any given position of a regulating guide with respect to a paper feed section, the regulating guide being provided movably relative to the paper feed section in order to regulate positional shifting of a medium in close proximity to an edge of the medium that has been loaded into the paper feed section; and

a step of performing printing on the medium.

Further, another primary aspect of the present invention consists in the following printing apparatus.

A printing apparatus includes:

a paper feed section into which a medium to be printed is loaded;

a regulating guide provided movably relative to the paper feed section for regulating positional shifting of the medium in close proximity to an edge of the medium loaded into the paper feed section;

a position detection pattern provided on the paper feed section side in order for the position of the regulating guide, with respect to the paper feed section, to be detected;

an optical sensor that is provided on the regulating guide side, that has a light-emitting section emitting light toward the position detection pattern and a light-receiving section receiving light reflected from the position detection pattern, and that outputs a signal corresponding to the intensity of the light received by the light-receiving section; and

a detection section for detecting the position of the regulating guide with respect to the paper feed section based on the signal outputted from the optical sensor.

Further, another primary aspect of the present invention consists in the following printing method.

A printing method includes:

a step of detecting a position, with respect to a paper feed section, of a regulating guide that is provided movably relative to the paper feed, section in order to regulate positional shifting of a medium in close proximity to an edge of the medium that has been loaded into the paper feed section, using
a position detection pattern provided on the paper feed section side, and
an optical sensor that has a light-emitting section and a light-receiving section and, by emitting light toward the position detection pattern from the light-emitting section and receiving light reflected from the position detection pattern with the light-receiving section, outputs a signal corresponding to the intensity of the light received by the light-receiving section; and

a step of performing printing on the medium.

Further, another primary aspect of the present invention consists in the following printing apparatus.

A printing apparatus includes;

a paper feed section into which a medium to be printed is loaded;

a regulating guide provided on the paper feed section for regulating positional shifting of the medium in close proximity to an edge of the medium loaded into the paper feed section; and

a sensor that detects whether or not the medium is present within a predetermined distance from the regulating guide.

Further, another primary aspect of the present invention consists in the following printing method.

A printing method includes;

a step of detecting, using a sensor, whether or not a medium is present within a predetermined distance from a regulating guide that is provided on a paper feed section in order to regulate positional shifting of the medium in close proximity to an edge of the medium when performing printing on the medium loaded into the paper feed section; and

a step of performing printing on the medium that has been loaded into the paper feed section.

### BRIEF DESCRIPTION OF THE DRAWINGS

For a more complete understanding of the present invention and the advantages thereof, reference is now made to the following description taken in conjunction with the accompanying drawings.

FIG. 1 is a perspective view of an embodiment of a printing apparatus.

FIG. 2 is a perspective view explaining an internal configuration of the printing apparatus.

FIG. 3 is a cross-sectional view illustrating a carrying section of the printing apparatus.

FIG. 4 is a block diagram illustrating a system configuration of the printing apparatus.

FIG. 5 is a flowchart explaining an example of print processing.

FIG. 6 is an explanatory diagram used for explaining a paper feed unit.

FIG. 7A is a plan view explaining a configuration of a position sensor.

FIG. 7B is a side view explaining a configuration of a position sensor.

FIG. 8A is a plan view explaining a configuration of another position sensor.

FIG. 8B is a side view explaining a configuration of another position sensor.

FIG. 9 is a diagram explaining an example of interaction between the printing apparatus and a computer.

FIG. 10 is a diagram explaining various standard sizes of media and their lateral width dimensions.

FIG. 11 is a diagram explaining the relationship of the lateral width dimensions of media of various standard sizes.

FIG. 12 is a diagram explaining another exemplary configuration of the paper feed unit.

FIG. 13 is a plan view explaining the configuration of a different type of position sensor.

FIG. 14 is a side view explaining the configuration of a different type of position sensor.

FIG. 15 is a diagram illustrating an example of a position detection pattern in detail.

FIG. 16 is a diagram of a system configuration provided with another type of position sensor.

FIG. 17 is a diagram illustrating an example of another type of position detection pattern.

FIG. 18 is a diagram illustrating an example of another type of position detection pattern.

FIG. 19 is a block diagram illustrating a system configuration of the printing apparatus.

FIG. 20 is an explanatory diagram used for explaining a paper feed unit.

FIG. 21 is a diagram explaining an exemplary configuration of an optical sensor.

FIG. 22 is a diagram illustrating an example of a position detection pattern in detail.

FIG. 23 is a diagram illustrating an example of another type of position detection pattern.

FIG. 24 is an explanatory diagram explaining an exemplary processing procedure.

FIG. 25 is an explanatory diagram of the lateral width dimensions of various standard sizes of media.

FIG. 26 is an explanatory diagram of the relationship of the various standard sizes of media and their lateral width dimensions.

FIG. 27 is a diagram explaining an example of another paper feed unit.

FIG. 28 is a diagram explaining an example of another position detection pattern.

FIG. 29 is a diagram explaining an example of another position detection pattern.

FIG. 30 is a diagram explaining an example of another position detection pattern.

FIG. 31 is a diagram explaining an example of another position detection pattern.

FIG. 32 is a block diagram illustrating a system configuration of the printing apparatus.

FIG. 33 is an explanatory diagram used for explaining a paper feed unit.

FIG. 34 is a diagram explaining a configuration of an optical sensor.

FIG. 35 is a flowchart explaining an exemplary processing procedure of the controller.

FIG. 36 is an explanatory diagram explaining the detection range of an optical sensor.

FIG. 37 is a diagram explaining an example of computer processing.

FIG. 38 is a diagram explaining an example, in which an optical sensor is provided on a fixed guide.

FIG. 39 is a diagram explaining another exemplary configuration of the paper feed section.

FIG. 40 is a block diagram illustrating a system configuration provided with a position sensor.

FIG. 41A is a plan view explaining an example of a position sensor.

FIG. 41B is a side view explaining an example of a position sensor.

FIG. 42A is a plan view explaining another exemplary configuration of the position sensor.

FIG. 42B is a side view explaining another exemplary configuration of the position sensor.

FIG. 43 is a plan view explaining another exemplary configuration of the position sensor.

FIG. 44 is a side view explaining another exemplary configuration of the position sensor.

FIG. 45 is an explanatory diagram explaining an example of a position detection pattern.

FIG. 46 is an explanatory diagram explaining another example of the position detection pattern.

FIG. 47 is a diagram explaining various standard sizes of media and their lateral width dimensions.

FIG. 48 is a diagram explaining the relationship of the lateral width dimensions of media of various standard sizes.

FIG. 49 is an explanatory diagram explaining another example of the position detection pattern.

FIG. 50 is a flowchart explaining an example of a regulating guide position detection procedure.

FIG. 51 is a flowchart explaining an example of computer processing.

FIG. 52 is a perspective view illustrating an exemplary external appearance of a printing system.

FIG. 53 is block diagram illustrating an exemplary system configuration of a printing system.

### DETAILED DESCRIPTION OF PREFERRED EMBODIMENTS

At least the following matters will be made clear by the description of the present specification and the accompanying drawings.

A printing apparatus includes:

a paper feed section into which a medium to be printed is loaded;

a regulating guide provided movably relative to the paper feed section for regulating positional shifting of the medium in close proximity to an edge of the medium loaded into the paper feed section; and

a position sensor capable of detecting any given position of the regulating guide with respect to the paper feed section.

With such a printing apparatus, providing a position sensor capable of detecting any given position of the regulating guide with respect to the paper feed section permits more accurate detection of the position of the regulating guide. As a result, the size of the media loaded into the paper feed section can be checked during printing etc.

In this printing apparatus, it is preferable that the position sensor has a variable resistor whose resistance value varies depending on the position of the regulating guide with respect to the paper feed section.

Any given position of the regulating guide can be easily detected if the position sensor has such a variable resistor.

In this printing apparatus, it is preferable that the variable resistor is a rotary variable resistor or a sliding variable resistor.

Thus, if the variable resistor is a rotary variable resistor or a sliding variable resistor, any given position of the regulating guide can be easily detected.

In this printing apparatus, it is preferable that, in order to detect the position of the regulating guide with respect to the paper feed section, the position sensor has a position detection pattern provided on the paper feed section side, an optical sensor that is provided on the regulating guide side, that has a light-emitting section emitting light toward the position detection pattern and a light-receiving section receiving light reflected from the position detection pattern, and that outputs a signal corresponding to the intensity of the light received by the light-receiving section, and a detection section for detecting the position of the regulating guide with respect to the paper feed section based on the signal outputted from the optical sensor.

Any given position of the regulating guide can be easily detected if the apparatus is provided with a position sensor of this construction.

In this printing apparatus, it is preferable that the position detection pattern is a pattern in which the reflectance of light emitted from the light-emitting section varies in a direction of movement of the regulating guide.

Thus, any given position of the regulating guide with respect to the paper feed section can be easily detected if a position detection pattern is a pattern in which the reflectance of light emitted from the light-emitting section varies in the direction of movement of the regulating guide.

In this printing apparatus, it is preferable that the pattern in which the reflectance of light varies is a pattern having at least two or more regions of different colors, with the proportion between the regions of different colors varying in the direction of movement of the regulating guide.

Thus, any given position of the regulating guide with respect to the paper feed section can be more easily detected if the pattern of varying light reflectance is a pattern having at least two or more regions of different colors, with the proportion between the regions of different colors varying in the direction of movement of the regulating guide.

In this printing apparatus, it is preferable that the pattern in which the reflectance of light varies is a pattern in which the darkness of color varies in the direction of movement of the regulating guide.

Thus, any given position of the regulating guide with respect to the paper feed section can be more easily detected if the pattern of varying light reflectance is a pattern in which the darkness of color varies in the direction of movement of the regulating guide.

In this printing apparatus, it is preferable that another regulating guide is provided in order to regulate positional shifting of the medium in close proximity to an edge of the medium from the side opposite from the above-mentioned regulating guide.

If another regulating guide of this type is provided, the positional shifting of the media loaded into the paper feed section can be sufficiently regulated.

In this printing apparatus, it is preferable that the detection of the any given position of the regulating guide by the position sensor is carried out when performing printing on the medium.

Performing the detection of any given position of the regulating guide when printing on the media allows for checking of the size of the media to be performed prior to printing and enables printing in accordance with the size of the media.

In addition, the following printing method can be implemented as well.

A printing method includes:

a step of detecting, using a position sensor, any given position of a regulating guide with respect to a paper feed section, the regulating guide being provided movably relative to the paper feed section in order to regulate positional shifting of a medium in close proximity to an edge of the medium that has been loaded into the paper feed section; and

a step of performing printing on the medium.

With such a printing method, providing a position sensor capable of detecting any given position of the regulating guide with respect to the paper feed section permits more accurate detection of the position of the regulating guide. As a result, the size of the media loaded into the paper feed section can be checked during printing etc.

In addition, the following printing apparatus can be implemented as well.

A printing apparatus includes:

a paper feed section into which a medium to be printed is loaded;

a regulating guide provided movably relative to the paper feed section for regulating positional shifting of the medium in close proximity to an edge of the medium loaded into the paper feed section;

a position detection pattern provided on the paper feed section side in order for the position of the regulating guide, with respect to the paper feed section, to be detected;

an optical sensor that is provided on the regulating guide side, that has a light-emitting section emitting light toward the position detection pattern and a light-receiving section receiving light reflected from the position detection pattern, and that outputs a signal corresponding to the intensity of the light received by the light-receiving section; and

a detection section for detecting the position of the regulating guide with respect to the paper feed section based on the signal outputted from the optical sensor.

With such a printing apparatus, the position of the regulating guide can be easily detected by reading the position detection pattern provided on the side of the paper feed section using the optical sensor provided on the side of the regulating guide. Moreover, the position of the regulating guide can be detected in a contactless manner. Thus, the size of the media loaded into the paper feed section can be detected in a highly accurate manner over an extended period of time.

In this printing apparatus, it is preferable that the position detection pattern is provided along a direction of movement of the regulating guide.

Thus, if the position detection pattern is provided along the direction of movement of the regulating guide, the position of the regulating guide can be easily detected by the optical sensor.

In this printing apparatus, it is preferable that the position detection pattern is a pattern in which the reflectance of light emitted from the light-emitting section varies in the direction of movement of the regulating guide.

Thus, any given position of the regulating guide with respect to the paper feed section can be easily detected if a position detection pattern is a pattern in which the reflectance of light emitted from the light-emitting section varies in the direction of movement of the regulating guide.

In this printing apparatus, it is preferable that the pattern in which the reflectance of light varies is a pattern having at least two or more regions of different colors, with the proportion between the regions of different colors varying in the direction of movement of the regulating guide.

Thus, any given position of the regulating guide with respect to the paper feed section can be easily detected if the pattern of varying light reflectance is a pattern having at least two or more regions of different colors, with the proportion between the regions of different colors varying in the direction of movement of the regulating guide.

In this printing apparatus, it is preferable that the pattern in which the reflectance of light varies is a pattern in which the darkness of color varies in the direction of movement of the regulating guide.

Thus, any given position of the regulating guide with respect to the paper feed section can be easily detected it the pattern of varying light reflectance is a pattern in which the darkness of color varies in the direction of movement of the regulating guide.

In this printing apparatus, it is preferable that the position detection pattern is made of a plurality of patterns, each pattern having a different reflectance of light emitted from the light-emitting section.

Thus, if the position detection pattern includes a plurality of patterns each having a different reflectance of light emitted from the light-emitting section, the position of the regulating guide can be detected in a contactless manner. Thus, the size of the media loaded into the paper feed section can be detected in a highly accurate manner over an extended period of time.

In this printing apparatus, it is preferable that each of the plurality of patterns having different light reflectances has a different darkness in color.

Thus, if each of the plurality of patterns of varying light reflectances has a different color darkness, the position of the regulating guide can be easily detected.

In this printing apparatus, it is preferable that each of the plurality of patterns having different light reflectances has at least two or more regions of different colors, with the proportion between the regions of different colors varying for each pattern.

Thus, if each one of the plurality of patterns of different light reflectances has at least two or more regions of different colors, with the proportion between the regions of different colors being different for each of the patterns, then the position of the regulating guide can be easily detected.

In this printing apparatus, it is preferable that the plurality of patterns having different light reflectances are provided in positions respectively corresponding to standard sizes of the medium.

Thus, if the plurality of patterns of varying light reflectances are provided in positions respectively corresponding to the standard sizes of the media, it can be easily determined whether or not the media to be printed on are of a standard size.

In this printing apparatus, it is preferable that the printing apparatus includes another regulating guide in order to regulate positional shifting of the medium in close proximity to an edge of the medium from the side opposite from the above-mentioned regulating guide.

If another such regulating guide is provided, the positional shifting of the media loaded into the paper feed section can be sufficiently regulated.

In this printing apparatus, it is preferable that the detection of the position of the regulating guide by the optical sensor is carried out when performing printing on the medium.

Performing the detection of any given position of the regulating guide when printing on the media allows for checking of the size of the media to be performed prior to printing and enables printing in a way that matches the size of the media.

In addition, the following printing method can be implemented as well.

A printing method includes:

a step of detecting a position, with respect to a paper feed section, of a regulating guide that is provided movably relative to the paper feed section in order to regulate positional shifting of a medium in close proximity to an edge of the medium that has been loaded into the paper feed section, using
a position detection pattern provided on the paper feed section side, and
an optical sensor that has a light-emitting section and a light-receiving section and, by emitting light toward the position detection pattern from the light-emitting section and receiving light reflected from the position detection pattern with the light-receiving section, outputs a signal corresponding to the intensity of the light received by the light-receiving section; and

a step of performing printing on the medium.

With such a printing method, the position of the regulating guide can be easily detected by reading the position detection pattern provided on the side of the paper feed section using the optical sensor provided on the side of the regulating guide. Moreover, the position of the regulating guide can be detected in a contactless manner. As a result, the size of the media loaded into the paper feed section can be detected in a highly accurate manner over an extended period of time.

In addition, the following printing apparatus can be implemented as well.

A printing apparatus includes:

a paper feed section into which a medium to be printed is loaded;

a regulating guide provided on the paper feed section for regulating positional shifting of the medium in close proximity to an edge of the medium loaded into the paper feed section; and

a sensor that detects whether or not the medium is present within a predetermined distance from the regulating guide.

With such a printing apparatus, providing a sensor for detecting the presence of media within a predetermined distance from the regulating guide permits detection of whether or not the regulating guide is in close proximity to the edge of the media. As a result, it can be confirmed whether or not the positional shifting of the media is sufficiently regulated by the regulating guide.

In this printing apparatus, it is preferable that the sensor is an optical sensor having a light-emitting section that emits light and a light-receiving section that receives light.

If the sensor provided in the apparatus is such an optical sensor, the presence of media within a predetermined distance from the regulating guide can be easily detected.

In this printing apparatus, it is preferable that the sensor is provided on the regulating guide.

Thus, the presence of media within a predetermined distance from the regulating guide can be easily detected if the sensor is provided on the regulating guide.

In this printing apparatus, it is preferable that the predetermined distance is set to not less than 1 mm and not more than 10 mm.

If the predetermined distance is set to this range, the positional shifting of the media can be sufficiently regulated by the regulating guide.

In this printing apparatus, it is preferable that the detection by the sensor of whether or not the medium is present is carried out when performing printing on the medium.

Thus, if the detection of the presence of media is carried out when printing on the media, it can be easily confirmed prior to printing whether or not the positional shifting of the media will be sufficiently regulated by the regulating guide.

In this printing apparatus, it is preferable that the regulating guide is a fixed guide provided integrally with the paper feed section.

Thus, it the regulating guide is a fixed guide, the positional shifting of the media loaded into the paper feed section can be sufficiently regulated.

In this printing apparatus, it is preferable that the regulating guide is a movable guide provided movably relative to the paper feed section.

Thus, if the regulating guide is a movable guide, the positional shifting of the media loaded into the paper feed section can be easily regulated.

In this printing apparatus, it is preferable that the printing apparatus includes a position sensor for detecting the position of the movable guide.

The position of the movable guide can be easily detected if the apparatus is provided with such a position sensor. This makes it possible to acquire the dimensions of the media to be printed upon.

In this printing apparatus, it is preferable that the position sensor detects any given position of the movable guide with respect to the paper feed section.

Thus, if the position sensor can detect any given position, the dimensions of the media to be printed upon can be acquired more precisely.

In this printing apparatus, it is preferable that the position sensor has a variable resistor whose resistance value varies depending on the position of the movable guide with respect to the paper feed section.

The position of the movable guide can be easily detected if the position sensor has such a variable resistor.

In this printing apparatus, it is preferable that in order to detect the position of the movable guide with respect to the paper feed section, the position sensor has: a position detection pattern provided on the paper feed section side; an optical sensor that is provided on the movable guide side, that has a light-emitting section emitting light toward the position detection pattern and a light-receiving section receiving light reflected from the position detection pattern, and that outputs a signal corresponding to the intensity of the light received by the light-receiving section; and a detection section for detecting the position of the movable guide with respect to the paper feed section based on the signal outputted from the optical sensor.

The position of the movable guide can be easily detected if the apparatus is provided with this type of position sensor.

In this printing apparatus, it is preferable that the position detection pattern is a pattern in which the reflectance of light emitted from the light-emitting section varies in a direction of movement of the movable guide.

If the apparatus is provided with such a pattern as the position detection pattern, any given position of the movable guide with respect to the paper feed section can be easily detected.

In this printing apparatus, it is preferable that the pattern in which the reflectance of light varies is a pattern having at least two or more regions of different colors, with the proportion between the regions of different colors varying in the direction of movement of the movable guide.

If the apparatus is provided with such a pattern as a pattern with varying light reflectance, any given position of the movable guide with respect to the paper feed section can be easily detected.

In this printing apparatus, it is preferable that the pattern in which the reflectance of light varies is a pattern in which the darkness of color varies in the direction of movement of the movable guide.

If the apparatus is provided with such a pattern as a pattern with varying light reflectance, any given position of the movable guide with respect to the paper feed section can be easily detected.

In addition, the following printing method can be implemented as well.

A printing method includes:

a step of detecting, using a sensor, whether or not a medium is present within a predetermined distance from a regulating guide that is provided on a paper feed section in order to regulate positional shifting of the medium in close proximity to an edge of the medium when performing printing on the medium loaded into the paper feed section; and

a step of performing printing on the medium that has been loaded into the paper feed section.

With such a printing method, the sensor that detects the presence of media within a predetermined distance from the regulating guide can detect whether or not the regulating guide is in close proximity to the edge of the media. As a result, it is possible to confirm whether or not the positional shifting of the media can be sufficiently regulated by the regulating guide.

In this printing method, it is preferable that the position of the regulating guide with respect to the paper feed section is detected by a position sensor after detecting whether or not the medium is present within a predetermined distance from the regulating guide.

With such a printing method, the dimensions of the media can be acquired in a reliable manner because the position of the regulating guide is detected by the position sensor after detecting the presence of media within the predetermined distance from the regulating guide.

### Overview of Printing Apparatus (First Embodiment)

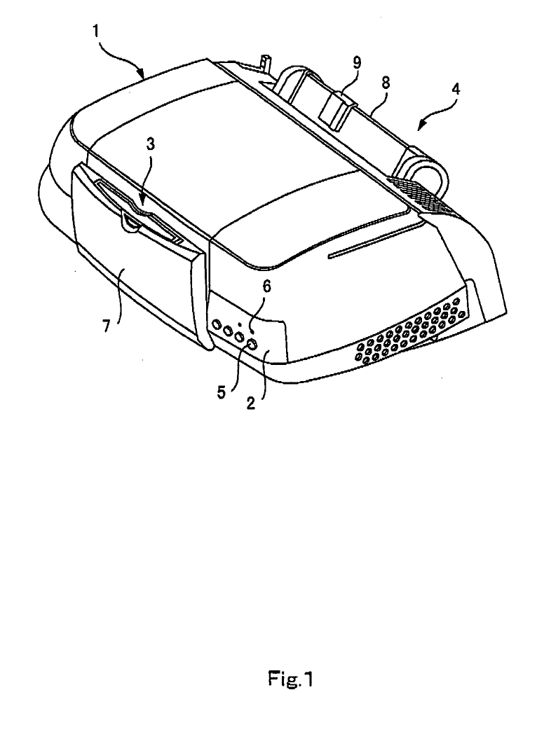

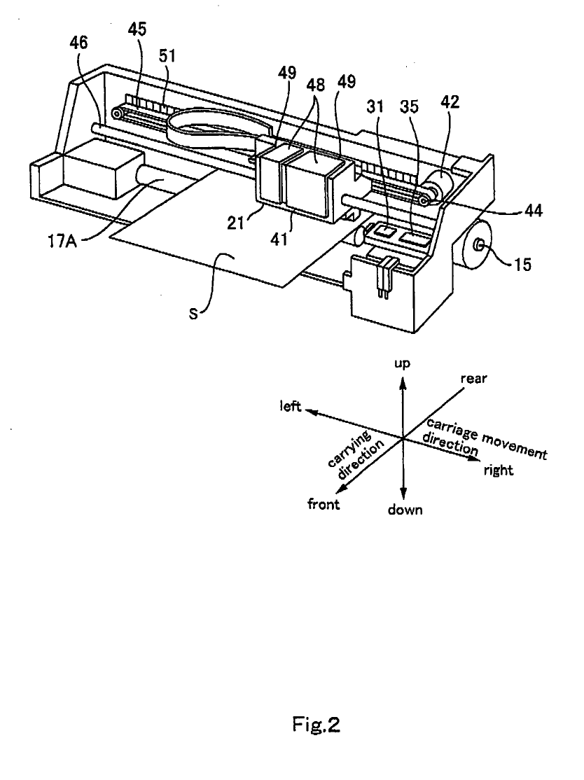

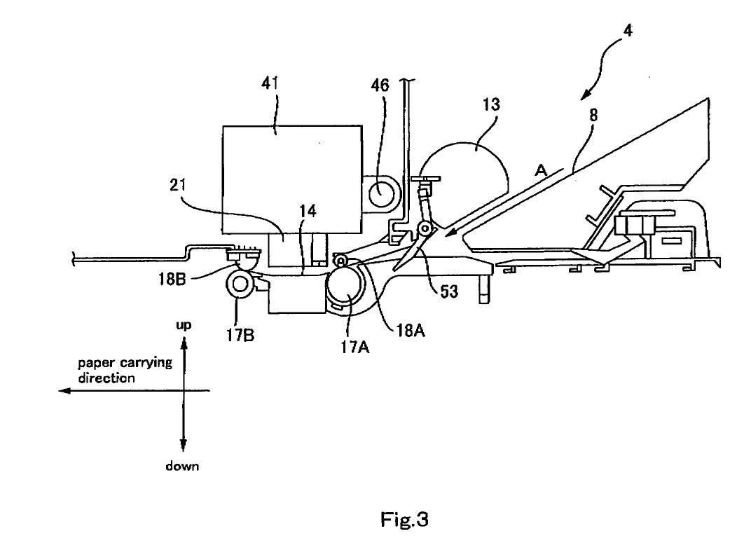

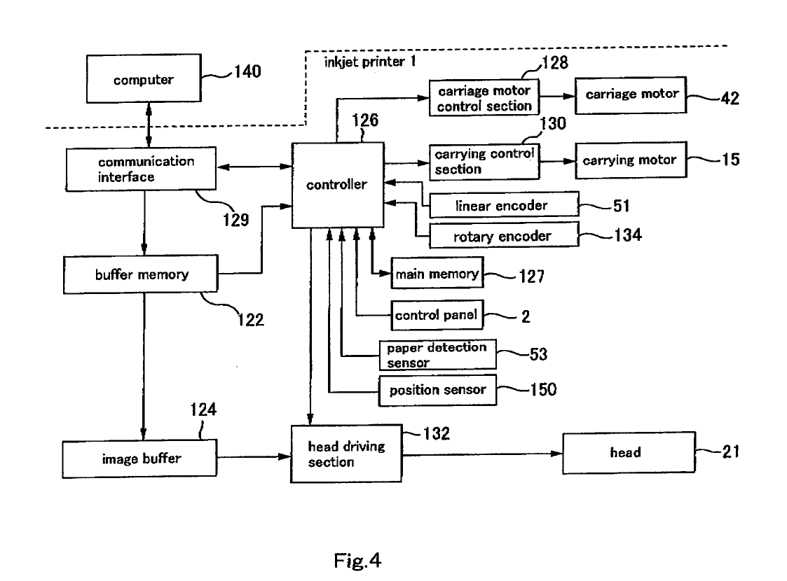

An embodiment of the printing apparatus according to the present invention will be explained using an inkjet printer as an example. FIG. 1-FIG. 4 illustrate an inkjet printer 1. FIG. 1 illustrates an external appearance of the inkjet printer 1. FIG. 2 illustrates an internal configuration of the inkjet printer 1. FIG. 3 illustrates a configuration of a carrying section in the inkjet printer 1. FIG. 4 illustrates a system configuration of the inkjet printer 1.

As shown in FIG. 1, the inkjet printer 1 is provided with a structure for frontal discharge of printing paper and other media supplied from the rear, with a control panel 2 and a paper discharge section 3 provided in the frontal portion and a paper feed unit 4 provided in the rear portion various operating buttons 5 and indicator lamps 6 are provided on the control panel 2. In addition, a paper discharge tray 7, which shuts the paper discharge opening when not in use, is provided in the paper discharge section 3. A paper feed tray 8 used to hold pre-cut paper and other media is provided in the paper feed unit 4. The paper feed tray 8 corresponds to the paper feed section. A paper guide 9 (corresponding to the regulating guide) used for regulating the positional shifting of paper and other media loaded into said paper feed tray 8 is provided in the paper feed tray 8. The configuration of the paper feed unit 4 will be described in detail below.

As shown in FIG. 2, a carriage 41 is provided inside the inkjet printer 1. The carriage 41 is provided in such a manner that it is relatively movable in the right/left direction. A carriage motor 42, a pulley 44, a timing belt 45, and a guide rail 46 are provided in the periphery of the carriage 41. The carriage motor 42, which is constituted by a DC motor etc., is a drive source used to effect relative movement of the carriage 41 in the right/left direction (also called “carriage movement direction” below). The timing belt 45, along with being connected to the carriage motor 42 via the pulley 44, has a portion connected to the carriage 41 and causes the carriage 41 to move in the carriage movement direction (right/left direction) under the action of the rotary drive of the carriage motor 42. The guide rail 46 guides the carriage 41 in the carriage movement direction (right/left direction).

In addition, a linear encoder 51 detecting the position of the carriage 41, a carrying roller 17A used for carrying media S in a direction intersecting with the direction of movement of the carriage 41 (in the figure, in the fore-and-aft direction, called the carrying direction below), and a carrying motor 15 for rotationally driving the carrying roller 17A are provided in the periphery of the carriage 41.

On the other hand, ink cartridges 48, which contain various inks, and a head 21, which performs printing on the media S, are provided in the carriage 41. The ink cartridges 48, which contain inks of various colors, such as yellow (Y), magenta (M), cyan (C), black (K) etc., are detachably installed in a cartridge-loading section 49 provided in the carriage 41. In addition, in the present embodiment, the head 21 carries out printing by ejecting ink onto the medium S. For this reason, multiple nozzles used for ejecting ink are provided in the head 21.

In addition, a pumping device 31, which aspires ink from the nozzles so as to eliminate the clogging of the nozzles of the head 21, a capping device 35, which seals the nozzles of the head 21 when printing stops (during standby operation, etc.) in order to prevent the clogging of the nozzles of the head 21, etc. are provided inside the inkjet printer 1.

Explanations regarding the carrying section of the inkjet printer 1 are provided next. As shown in FIG. 3, a paper feed roller 13, a paper detection sensor 53, a carrying roller 17A, a paper discharge roller 172, a platen 14, and free rollers 18A, 18B are provided in the carrying section.

Media S being printed upon are loaded into the paper feed tray 8. The medium S loaded into the paper feed tray 8 is carried in the direction of arrow A in the figure by the paper feed roller 13, which has a nearly D-shaped cross-section, and are fed into the inkjet printer 1. The medium S brought inside the inkjet printer 1 comes in contact with the paper detection sensor 53. The paper detection sensor 53, which is disposed between the paper feed roller 13 and the carrying roller 17A, detects the medium S fed by the paper feed roller 13.

The medium S detected by the paper detection sensor 53 is successively carried by the carrying roller 17A to the platen 14, where printing takes place. The free roller 18A is provided in a position that is opposite to the carrying roller 17A. The medium S is nipped between the free roller 18A and the carrying roller 17A, and, as a result, the medium S is carried in a smooth fashion.

The medium S brought to the platen 14 is successively printed upon using ink ejected from the head 21. The platen 14, which is provided opposite to the head 21, supports the medium S being printed upon from below.

The medium S that has been printed upon is successively discharged from the printer by the paper discharge roller 17B. The paper discharge roller 17B, which is driven in synchronization with the carrying motor 15, and the free roller 18B, which is provided opposite to said paper discharge roller 17B, nip the medium S and discharge the medium S outside the printer.

<System Configuration>

Explanations regarding the system configuration of the inkjet printer 1 are provided next. As shown in FIG. 4, the inkjet printer 1 includes a buffer memory 122, an image buffer 124, a controller 126, a main memory 127, a communication interface 129, a carriage motor control section 128, a carrying control section 130, and a head driving section 132.

The communication interface 129 is used for data exchange between the inkjet printer 1 and, for instance, an external computer 140, such as a PC, etc. The communication interface 129, which is connected to the external computer 140 by a wired or wirelessly to enable communication, receives print data and various other data sent from the computer 140.

The print data and various other data received by the communication interface 129 are temporarily stored in the buffer memory 122. In addition, the print data stored in the buffer memory is successively stored in the image buffer 124. The print data stored in the image buffer 124 is successively sent to the head driving section 132. In addition, the main memory 127 is constituted by a ROM, RAM, EEPROM, etc. Various programs and data related to various settings used for controlling the inkjet printer 1 are stored in the main memory 127.

The controller 126 performs overall control over the inkjet printer 1 according to control programs and data related to various settings by reading said the control programs and data related to settings from the main memory 127. In addition, detection signals from various sensors, such as a rotary encoder 134, a linear encoder 51, a paper detection sensor 53, etc. are inputted to the controller 126.

When print data and various other data sent from the external computer 140 are received by the communication interface 129 and stored in the buffer memory 122, the controller 126 reads the necessary information from the data stored in the buffer memory 122. The controller 126 controls the carriage motor control section 128, the carrying control section 130, and the head driving section 132, etc., in accordance with the control programs based on the information it reads, while taking into account the output of the linear encoder 51 and the rotary encoder 134.

The carriage motor control section 128 exercises drive control to set the direction of rotation, rotational speed, torque, etc. of the carriage motor 42 in accordance with commands received from the controller 126. The carrying control section 130 controls the drive of the carrying motor 15 rotationally driving the carrying roller 17A in accordance with commands received from the controller 126.

The head driving section 132 exercises drive control over the nozzles of different colors provided in the head 21 based on the print data stored in the image buffer 124 in accordance with commands received from the controller 126.

In addition, the inkjet printer 1 of the present embodiment is provided with a position sensor 150, which detects the position of the paper guide 9. The configuration of the position sensor 150 is described in detail below.

Printing Operation

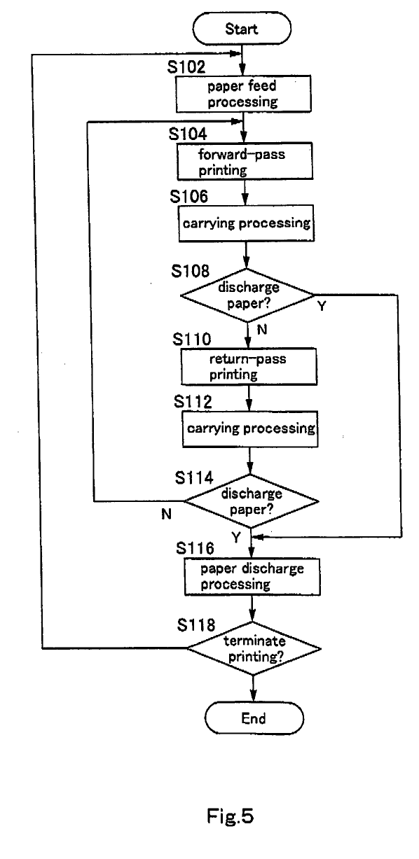

Explanations regarding the printing operation of the above-described inkjet printer 1 are provided next. Here, explanations will be provided using “bidirectional printing” by way of an example. FIG. 5 is a flowchart illustrating an example of the processing procedure used in the printing operation of the inkjet printer 1. The various types of processing set forth hereinbelow are executed by the controller 126 by reading the programs from the main memory 127 and controlling the carriage motor control section 128, the carrying control section 130, the head driving section 132, etc. in accordance with said programs when the controller 126 receives print data from the computer 140, at first, it performs paper feed processing in order to execute printing based on the print data (S102). The paper feed processing involves supplying the medium S to be printed upon into the inkjet printer 1 and carrying it to the starting position for printing (also called the “indexed position”). The controller 126 rotates the paper feed roller 13 to feed the medium S to be printed to the carrying roller 17A. The controller 126 rotates the carrying roller 17A so as to position the medium S fed from the paper feed roller 13 at the starting position for printing (around and above the platen 14).

Next, the controller 126 drives the carriage motor 42 via the carriage motor control section 128 to execute print processing, during which printing on the media S is carried out by moving the carriage 41 relative to the medium S. Here, first of all, forward-pass printing is performed, during which the carriage 41 is moved in one direction along the guide rail 46 while ink is ejected from the head 21 (S104). Along with moving the carriage 41 by driving the carriage motor 42, the controller 126 drives the head 21 to eject ink based on print data. The ink ejected from the head 21 reaches the medium S and forms dots.

After conducting printing in this manner, the controller 126 executes carrying processing, during which the medium S is carried by a predetermined amount (S106). Here, the controller 126 rotates the carrying roller 17A by driving the carrying motor 15 via the carrying control section 130 and carries the media S by a predetermined amount in the carrying direction relative to the head 21. The carrying processing enables the head 21 to perform printing in areas other than the previously printed area.

After conducting carrying processing in this manner, the controller 126 makes a paper discharge decision with regard to whether or not the paper should be discharged (S108). Here, the controller 126 executes paper discharge processing it there is no other data to be printed on the medium S used for printing (S116). On the other hand, the controller 126 performs return-pass printing without executing paper discharge processing if there is other data to be printed on the medium S used for printing (S110). During the return-pass printing, printing is carried out by moving the carriage 41 along the guide rail 46 in the direction opposite to the direction of the previously conducted forward-pass printing. Here, too, along with moving the carriage 41 by rotationally driving the carriage motor 42 in the direction opposite to the previous direction via the carriage motor control section 128, the controller 126 carries out printing by ejecting ink by driving the head 21 based on the print data.

After performing the return-pass printing, carrying processing (S112) is carried out, followed by making a paper discharge decision (Sl14). Here, processing goes back to Step 104 and forward-pass printing is carried out again without performing paper discharge processing if there is other data to be printed on the media S used for printing (S104). On the other hand, paper discharge processing is carried out if there is no other data to be printed upon the medium S used for printing (S116).

Next, after performing paper discharge processing, a printing termination decision is made, wherein it is decided whether or not to terminate printing (S118). Here, next, a check is performed as to whether or not the next medium S is to be printed based on the print data received from the computer 140. Here, when there are more media S to be printed upon, processing returns to Step 102 and printing starts once again by performing paper feed processing. On the other hand, when there are no more media S to be printed upon, print processing is terminated.

Configuration of the Paper Feed Unit

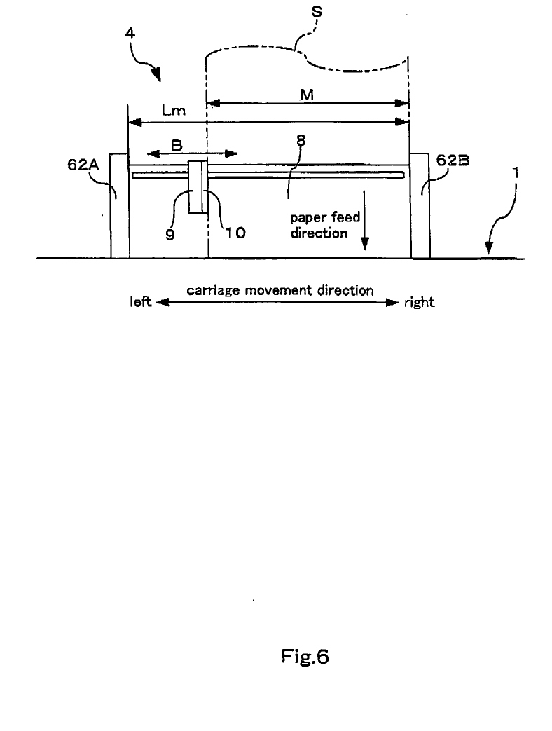

FIG. 6 illustrates the configuration of the paper feed unit 4 of the inkjet printer of this embodiment in detail. As shown in FIG. 1 as well, a paper feed tray 8 and a paper guide 9 used for regulating the positional shifting of the media S such paper sheets loaded into the paper feed tray 8 are provided in the paper feed unit 4. The media S to be printed upon are loaded into the paper feed tray 8. The number of sheets of the media S loaded into the paper feed tray 8 is between one and several dozen sheets. As shown in FIG. 6, protruding sections 62A, 62B are provided along the side edge portions of the paper feed tray 8 (in the feed direction of the media S), on the right and left sides of the paper feed tray 8. The spacing Lm between these two protruding sections 62A, 62B is set in accordance with the maximum size of the media S that the inkjet printer 1 is capable of printing. The media S are loaded between these two protruding sections 62A, 62B.

On the other hand, as shown in the same diagram, the paper guide 9 is provided slidably in the lateral width direction of the paper feed tray 8, i.e. in the direction of arrow B in the diagram. The paper guide 9 is moved so as to match the width dimension M of the media S loaded into the paper feed tray 8. The media S are loaded between the paper guide 9 and one of the protruding sections 62A, 62B of the paper feed tray 8, in this case the protruding section 6213 on the right. The paper guide 9 is disposed in close proximity to the edge of the media S loaded into the paper feed tray 8, in this case in close proximity to the left edge of the media S. During printing, when the media S loaded into the paper feed tray 8 are fed to the printing section, i.e. the platen 14, the paper guide 9 and the protruding section 62B on the right clamp the media S and guide the media S such that no positional shifting of the media S takes place.

The adjustment of the position of the paper guide 9 is carried out by the user. The user grips a tab section 10, which is provided on the paper guide 9, and moves the paper guide 9 so as to position it in close proximity to the edge of the media S to match the lateral width dimension M of the media S loaded into the paper feed tray 8.

Position Sensor

<Overview of the Sensor>

The inkjet printer 1 of this embodiment is provided with a position sensor 150 used for detecting the current position of the paper guide 9 provided in the paper feed tray 8. The position sensor 150 can detect any given position of the paper guide 9 with respect to the paper feed tray 8. The position sensor 150 is provided, for instance, in the rear side portion of the paper feed tray 8. As shown in FIG. 4, the detection results of the position sensor 150 are transmitted to the controller 126. Namely, a detection signal corresponding to the position of the paper guide 9 is outputted from the position sensor 150 to the controller 126. The controller 126 acquires information on the current position of the paper guide 9 based on the detection signal received from the position sensor 150.

<Configuration of the Sensor (1)>

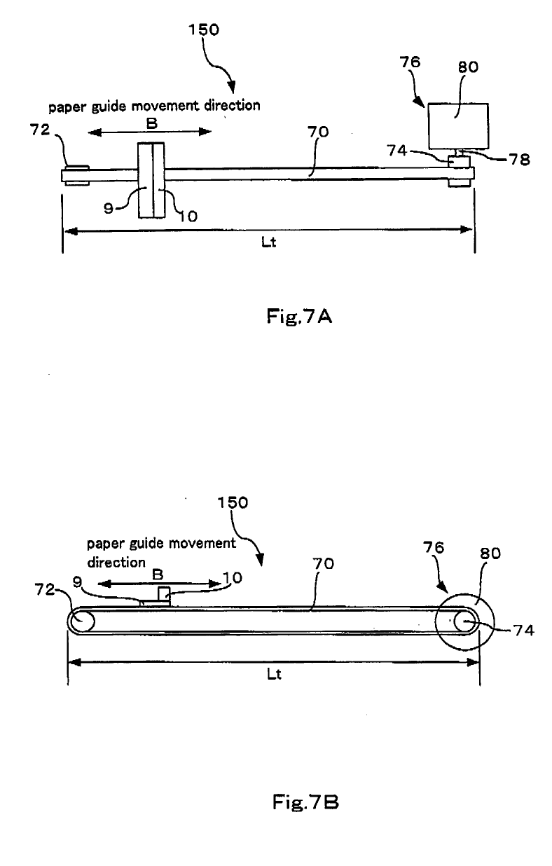

FIG. 7A and FIG. 7B offer a simplified illustration of an exemplary configuration of the position sensor 150 provided in the inkjet printer 1 of this embodiment. FIG. 7A is a plan view explaining the configuration of the position sensor 150 and FIG. 7B is a side view explaining the configuration of the position sensor 150.

As shown in FIG. 7A and FIG. 7B, the position sensor 150 is provided with an endless belt 70 integrally joined to the paper guide 9, a pulley 72 provided at one reach of the endless belt 70, and a rotary variable resistor 76 provided at the other reach of the endless belt 70 via a pulley 74. The endless belt 70 is provided along the direction of movement of the paper guide 9. Its length Lt is set in accordance with the moving range of the paper guide 9. In addition, the endless belt 70 is suspended between the two pulleys 72, 74.

On the other hand, the rotary variable resistor 76 is provided with a rotary shaft 78 provided integrally with the pulley 74 and a variable resistor main body 80, which is used to detect the amount of rotation of the rotary shaft 78. When the endless belt 70 rotates as a result of the movement of the paper guide 9, the rotary shaft 78 is rotated via the pulley 74. The resistance value of the variable resistor main body 80 changes depending on the amount of rotation of the rotary shaft 78. Namely, for instance, when the paper guide 9 moves to the left, the resistance value increases, and when the paper guide 9 moves in the opposite direction, i.e. to the right, the resistance value decreases. As a result, the current location of the paper guide 9 can be acquired based on the current resistance value of the variable resistor main body 80.

Information on the resistance value of the variable resistor main body 80 is transmitted to the controller 126. The controller 126 detects the current position of the paper guide 9 based on the information on the resistance value of the variable resistor main body 80.

<Configuration of the Sensor (2)>

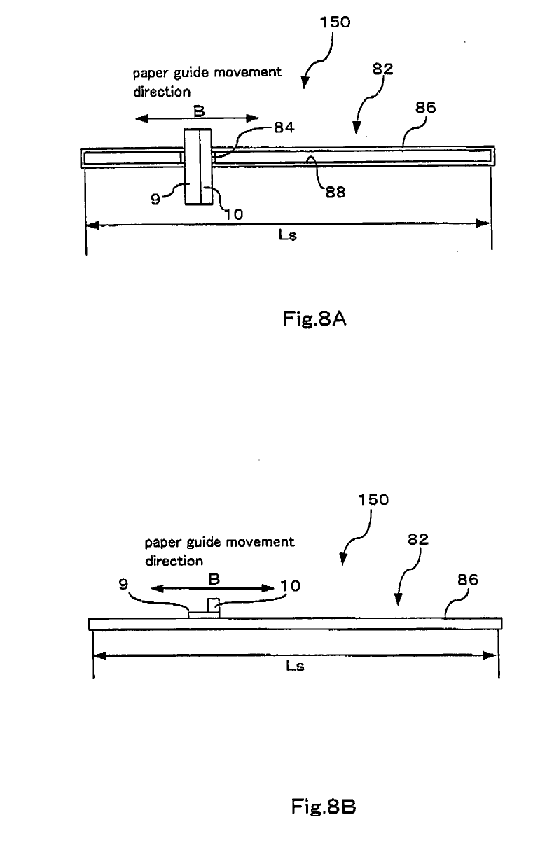

FIG. 8 explains a configuration used when a different variable resistor is utilized in the position sensor 150 provided in the inkjet printer 1 of this embodiment. FIG. 8A is a plan view explaining the configuration of the position sensor 150 and FIG. 8B is a side view explaining the configuration of the position sensor 150.

As shown in FIG. 8A and FIG. 8B, the variable resistor that the position sensor 150 is provided with is a sliding variable resistor 82. Here, the sliding variable resistor 82 is provided with a sliding block 84 integrally joined to the paper guide 9 and a variable resistor main body 86 capable of detecting the amount of movement of the sliding block 84.

The variable resistor main body 86 is provided along the direction of movement of the paper guide 9. As shown in FIG. 8A, a guiding groove 88 used for guiding the sliding block 84 is provided in the variable resistor main body 86. The guiding groove 88 is formed along the direction of movement of the paper guide 9 and its length Ls is set in accordance with the moving range of the paper guide 9. When the paper guide 9 moves, the sliding block 84 moves relatively along the guiding groove 88.

On the other hand, when the sliding block 84 moves along the guiding groove 88, the resistance value of the variable resistor main body 86 changes depending on the amount of movement. Namely, for instance, when the paper guide 9 moves to the left, the resistance value increases, and, when the paper guide 9 moves in the opposite direction, i.e. to the right, the resistance value decreases. As a result, the current location of the paper guide 9 can be acquired based on the current resistance value of the variable resistor main body 86.

Information on the resistance value of the variable resistor main body 86 is transmitted to the controller 126. The controller 126 detects the current position of the paper guide 9 based on the information on the resistance value of the variable resistor main body 86.

Processing Executed by the Controller, etc.

The controller 126 acquires information on the current position of the paper guide 9 from the position sensor 150 based on instructions from the externally connected computer 140. The controller 126 then transmits the information acquired from the position sensor 150 to the computer 140. The computer 140 executes print processing based on the information on the current position of the paper guide 9 acquired from the controller 126.

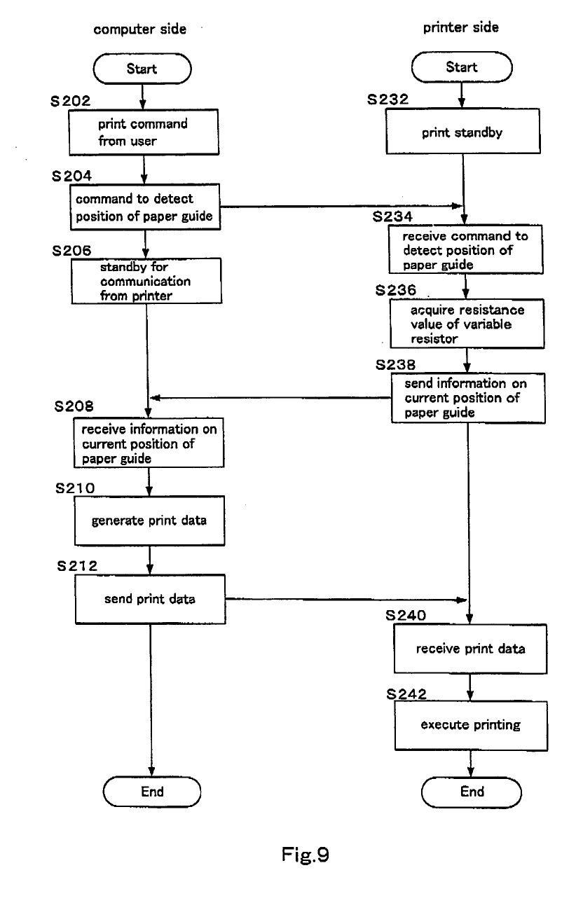

FIG. 9 explains an example of a series of interactions between the controller 126 and the computer 140. When a print command is issued by the user (S202), the computer 140 issues a command for the inkjet printer 1 to detect the position of the paper guide 9 (S204).

Upon receipt of the command to detect the position of the paper guide 9 from the computer 140 (S234) while in a print standby state (S232), the controller 126 of the inkjet printer 1 acquires information on the resistance value of the variable resistor 76 or 82 from the position sensor 150 (S236). The controller 126 acquires information on the current position of the paper guide 9 from the information on the resistance value of the variable resistor 76 or 82 and sends this information to the computer 140 (S238).

The computer 140 receives information on the current position of the paper guide 9 from the inkjet printer 1 (S208). The computer 140 then generates print data based on the received information (S210). Here, the computer 140 acquires information on the size of the media S actually loaded into the paper feed tray 8 from the information on the current position of the paper guide 9 supplied from the inkjet printer 1 and, based on this information, generates print data that permits images be printed so as to match the size of the media S to be printed upon. The computer 140 sends the generated print data to the inkjet printer 1 (S212).

Upon receiving the print data from the computer 140 (S240), the controller 126 of the inkjet printer 1 performs print processing (S242) based on the received print data and carries out printing on the media S.

Relationship Between Size and Lateral Width Dimensions of Media

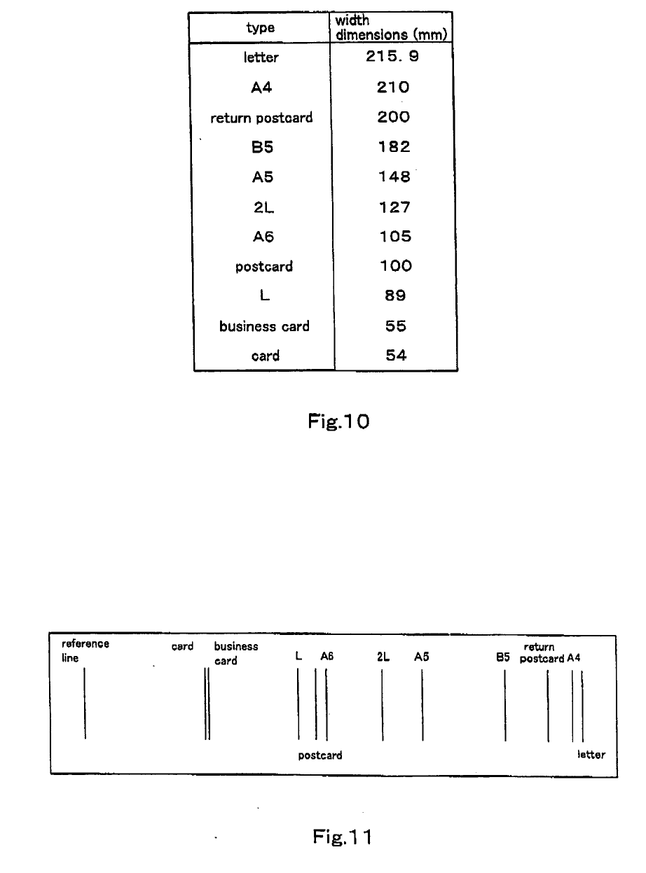

FIG. 10 is a diagram specifically illustrating various standard sizes of media S and their lateral width dimensions. FIG. 11 is a diagram specifically illustrating the relationship of the lateral width dimensions of various media S. Here, the medium of the largest size is “letter”. Starting from the “letter” size, the lateral width dimensions become successively smaller in the following order; “A4”, “return postcard”, “B5”, “A5”, “2L”, “A6”, “postcard”, “L”, “business card”, and “card”. Thus, the type of the media S can be distinguished by detecting the lateral width dimensions, because the lateral width dimensions vary depending on the type of the media S.

Moreover, in the inkjet printer 1 of this embodiment, the position sensor 150 is capable of detecting any given position of the paper guide 9. Accordingly, it is possible to accurately detect the position of the paper guide 9 and allow for the type of the media S to be distinguished relatively easily even in case of media whose lateral width dimensions are not particularly different, such as, for instance, “letter” and “A4”, “A4” and “post-card”, “A6” and “post-card”, “business card” and “card”.

It should be noted that processing for distinguishing the type of the media S based on the detection results received from the position sensor 150 that is preformed in this embodiment can be carried out by the controller 126 of the inkjet printer 1 or by the externally connected computer 140.

Summary

In the inkjet printer 1 of the embodiment above, providing the position sensor 150, which can detect any given position of the paper guide 9 with respect to the paper feed tray 8, enables accurate acquisition of the sizes of the media S loaded into the paper feed tray 8. As a result, the size of the media S to be printed on can be checked during printing etc.

In addition, in this embodiment, the position of the paper guide 9 can be detected in a very accurate and simple manner because the position sensor 150 is constituted by the variable resistors 76, 82.

In addition, since the position sensor 150 in this embodiment is capable of detecting any given position of the paper guide 9, it is possible to easily distinguish even media whose lateral width dimensions are not particularly different, such as, for instance, “letter” and “A4”, “A4” and “post-card”, “A6” and “post-card”, “business card” and “card”, etc.

Additionally, in this embodiment, using the position sensor 150 to check the size of the media S loaded into the paper feed tray 8 in advance, prior to printing, enables generation of print data in accordance with the size of the media S to be printed upon. As a result, even if the size of the media S set by the user is different from the size of the actual media S to be printed upon, print processing can be executed appropriately for the size of the actual media S to be printed upon.

Configuration of Another Paper Feed Unit

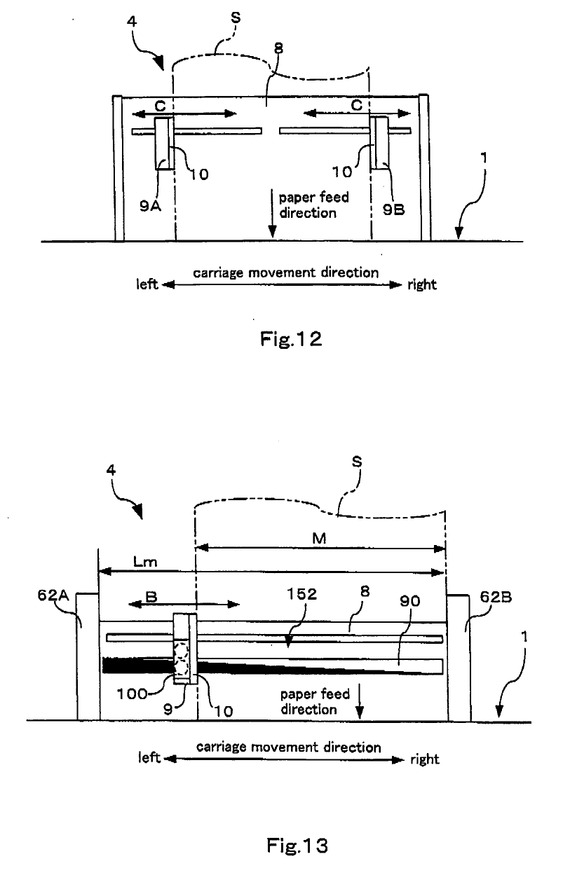

FIG. 12 is a diagram explaining the configuration of another paper feed unit 4. Here, a paper feed tray 8 and paper guides 9A, 9B are provided in the paper feed unit 4. The media S being printed upon are loaded into the paper feed tray 8. The paper guides 9A, 9B are provided for the purpose of regulating the positional shifting of the media S such as a paper sheet loaded into the paper feed tray 8. The media S are loaded between the two paper guides 9A, 9B. The two paper guides 9A, 9B clamp the media S loaded into the paper feed tray 8 from the right and left sides and, during printing, when the media S are sent to the printing section, i.e. the platen 14, they guide the media S such that no positional shifting of the media S takes place. It should be noted that either one of these two paper guides 9A, 9B corresponds to the regulating guide, with the other one corresponding to another regulating guide.

Also, as shown in the same diagram, the two paper guides 9A, 9B are provided slidably in the lateral width direction of the paper feed tray 8, i.e. in the direction of arrow C in the diagram. The two paper guides 9A, 9B are configured to move in the direction of arrow C in the diagram in a mutually interlocked fashion. Namely, when one of the paper guides 9A moves, the other paper guide 9B moves as well in an interlocked fashion. That is, a mechanism, not shown, which causes the two paper guides 9A, 9B to move in a mutually interlocked fashion is provided in the rear portion etc. of the paper feed tray 8. Here, when one of the paper guides 9A moves in the direction away from the other paper guide 9B, the other paper guide 9B also moves in an interlocked fashion in the direction away from the first paper guide 9A. Also, when one of the paper guides 9A moves in the direction toward the other paper guide 9B, the other paper guide 9B also moves in an interlocked fashion in the direction toward the first paper guide 9A. Thus, the media S loaded into the paper feed tray 8 can be always loaded in the center of the paper feed tray 8.

In this manner, providing two slidable paper guides 9A, 9B enables acquisition of the lateral width dimensions of the media S loaded into the paper feed tray 8 as long as it is possible to detect the position of at least one of the two paper guides 9A, 9B. This makes it possible to distinguish the size and type of the media S.

Another Position Sensor

<Overview of the Sensor>

FIG. 13 explains the configuration of another position sensor. As shown in FIG. 13, the position sensor 152 is provided with a position detection pattern 90 and an optical sensor 100, which reads the position detection pattern 90. The position detection pattern 90 is provided on the side of the paper feed tray 8 in order for the position of the paper guide 9 to be detected. The position detection pattern 90 is formed on the top face of the paper feed tray 8 in the shape of a strip in the direction of movement of the paper guide 9, i.e. in the direction of movement of the carriage 41. The position detection pattern 90 is printed on a sheet or a piece of adhesive tape, etc. and attached to the paper feed tray 8 by adhesion, etc.

On the other hand, as shown in the same diagram, the optical sensor 100 is provided on the paper guide 9. The optical sensor 100 is provided above the position detection pattern 90 provided on the paper feed tray 8 and faces the position detection pattern 90. When the paper guide 9 moves, the optical sensor 100 moves in tandem with the paper guide 9 along the position detection pattern 90 and above the position detection pattern 90.

<Configuration of the Optical Sensor>

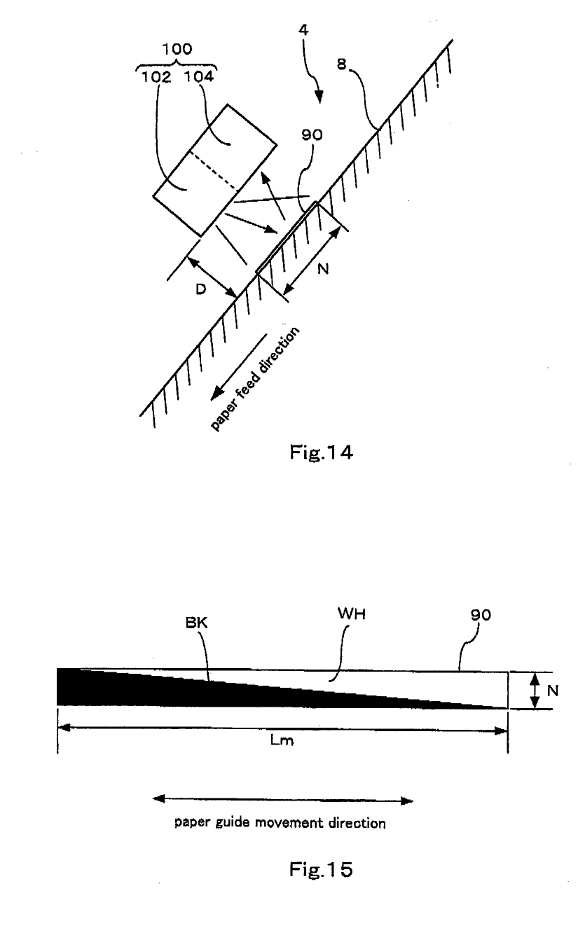

FIG. 14 is a diagram explaining the configuration of the optical sensor 100 in detail. The optical sensor 100 is a reflective optical sensor and, as shown in the same diagram, it is provided with a light-emitting section 102, which emits light, and a light-receiving section 104, which receives light. The light-emitting section 102 and light-receiving section 104 are arranged facing the position detection pattern 90 at a predetermined spacing D from the position detection pattern 90. The light-emitting section 102, which is constituted, for instance, by a light-emitting diode etc., emits light toward the position detection pattern 90. On the other hand, the light-receiving section 104, which is constituted e.g. by a phototransistor etc., receives light reflected by the position detection pattern 90.

The spot size of the light emitted by the light-emitting section 102 is set to be either nearly equal to, or greater than, the longitudinal width dimension N of the position detection pattern 90. As a result, light emitted from the light-emitting section 102 illuminates the entire position detection pattern 90 in its longitudinal width direction. Light reflected from the entire position detection pattern 90 in its longitudinal width direction is incident on the light-receiving section 104.

The light-receiving section 104 generates and outputs a signal corresponding to the intensity of the light incident on said light-receiving section 104. That is, for instance, a high-level signal is generated and outputted when the intensity of the light incident on the light-receiving section 104 is high. Also, for instance, a low-level signal is generated and outputted when the intensity of the light incident on the light-receiving section 104 is low.

The signal generated by the light-receiving section 104 is outputted outside from the optical sensor 100 as a detection signal. In this embodiment, the signal generated by the light-receiving section 104 of the optical sensor 100 is outputted to the controller 126.

<Position Detection Pattern>

The position detection pattern 90 is described below. FIG. 15 is a diagram illustrating the position detection pattern 90 in detail. As shown in the same diagram, the position detection pattern 90 of this embodiment has two regions of different colors, i.e. a white region WH formed in the shape of a right triangle and a black region BK similarly formed in the shape of a right triangle. The right triangle-shaped white region WH and black region BK have their hypotenuses mutually joined such that these two right triangle-shaped regions WE and BK form an elongated position detection pattern 90 shaped like a rectangle.

The white region WH is provided such that it tapers off on the left side of the position detection pattern 90. In addition, the black region BK is provided such that it tapers off on the right side of the position detection pattern 90. As a result, the proportion between the white region WH and the black region BK varies in the direction of movement of the paper guide 9. That is, the proportion of the black region BK becomes larger than the proportion of the white region WE in the left portion of the position detection pattern 90. In addition, the proportion of the white region WE becomes larger than the proportion of the black region BK in the right portion of the position detection pattern 90.

In this manner, the proportion of the white region WH to the black region BK varies depending on the position along the position detection pattern 90, thereby causing variation in the reflectance of the light emitted from the light-emitting section 102. That is, the reflectance of light becomes lower in the right portion of the position detection pattern 90, where the proportion of the white region WH is larger than the proportion of the black region BK. Also, the reflectance of light becomes higher in the right portion of the position detection pattern 90, where the proportion of the white region WH is larger than the proportion of the black region BK. In other words, the reflectance of light emitted from the light-emitting section 102 gradually decreases in the direction of movement of the paper guide 9 from the right portion of the position detection pattern 90 to its left portion.

Thus, by varying the reflectance of light emitted from the light-emitting section 102 depending on the position along the position detection pattern 90, it becomes possible to detect the current position of the paper guide 9. That is, since the intensity of the reflected light varies depending on the position along the position detection pattern 90, the position of the paper guide 9 can be detected by determining the intensity of the reflected light.

In particular, any given position of the paper guide 9 with respect to the paper feed tray 8 can be detected because the proportion of the white region WH to the black region BK in the position detection pattern 90 of this embodiment gradually changes in the direction of movement of the paper guide 9.

In addition, since the length Lm of the position detection pattern 90 is set in accordance with the moving range of the paper guide 9, the position of the paper guide 9 can be detected regardless of where it is located.

<Sensor Control Section>

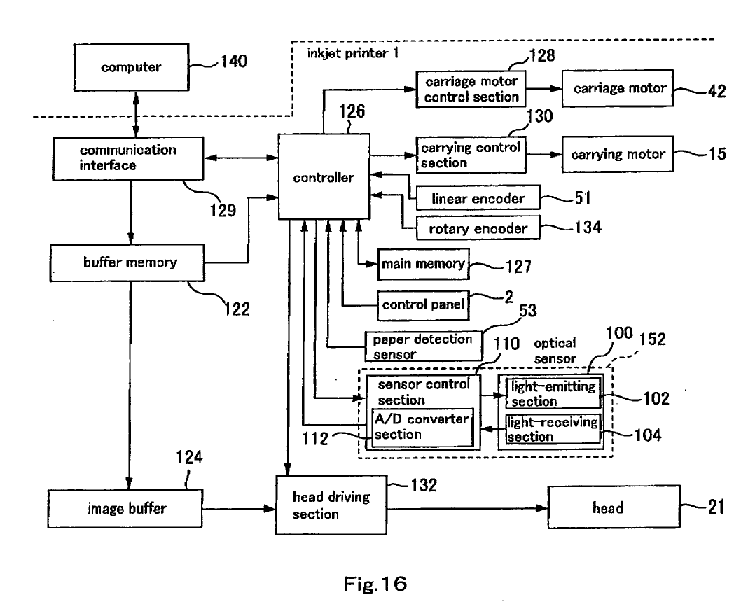

Drive control over the optical sensor 100 of this embodiment is exercised by a sensor control section 110. FIG. 16 illustrates the system configuration of the inkjet printer 1 of this embodiment when it is provided with the optical sensor 100 and the sensor control section 110. It should be noted that since constituent elements other than the optical sensor 100 and sensor control section 110 have been described above, their description is omitted.

The sensor control section 110 drives the optical sensor 100 in accordance with commands received from the controller 126. Namely, when a command is issued by the controller 126, the sensor control section 110 causes the light-emitting section 102 of the optical sensor 100 to emit light or to stop emission from the light-emitting section 102. Furthermore, the sensor control section 110 is provided with an A/D converter section 112. The AID converter section 112 performs conversion of signals outputted from the light-receiving section 104 of the optical sensor 100 from analog signals to digital signals. Specifically, the sensor control section 110 performs A/D conversion of the signal outputted from the optical sensor 100 into a digital signal and outputs it as digital data to the controller 126.

<Processing Executed by the Controller>

The controller 126 detects the current position of the paper guide 9 based on the information outputted from the sensor control section 110 regarding the intensity of the light received by the light-receiving section 104 of the optical sensor 100. That is, here, the controller 126 determines that as the intensity of the light received by the light-receiving section 104 grows stronger, the paper guide 9 moves to the right side of the paper feed tray 8. On the other hand, the controller 126 determines that as the intensity of the light received by the light-receiving section 104 becomes weaker, the paper guide 9 moves to the left side of the paper feed tray 8.

As a result, the controller 126 can detect the current position of the paper guide 9. Moreover, the controller 126 can detect any given position of the paper guide 9 because, as shown in FIG. 15, the reflectance of the light emitted by the light-emitting section 102 of the optical sensor 100 varies from the right side of the position detection pattern 90 to its left side. It should be noted that the controller 126 of this embodiment corresponds to the detection section.

Another Position Detection Pattern <1>

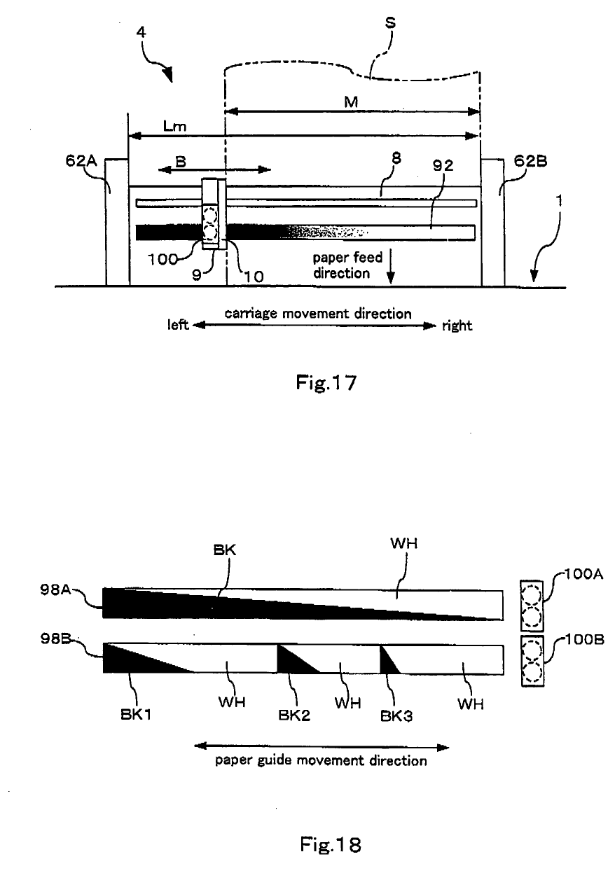

FIG. 17 explains an example of another type of position detection pattern 92. As shown in the same diagram, the position detection pattern 92 used here is a pattern, in which the darkness of color varies in the direction of movement B of the paper guide 9. Here, black color darkness varies in the direction of movement B of the paper guide 9. In addition, the darkness of color is set so as to gradually increase from the right edge to the left edge of the position detection pattern 92. That is, black color darkness becomes lighter at the right edge of the position detection pattern 92, producing a near-white color. Also, black color darkness becomes darker at the left edge of the position detection pattern 92, producing a near-black color. The gray color becomes gradually darker from the right edge to the left edge of the position detection pattern 92.

In this manner, the darkness of the color varies depending on the position along the position detection pattern 92 in the direction of movement of the paper guide 9, thereby causing variation in the reflectance of the light emitted from the light-emitting section 102. In other words, here, the reflectance of light is lower at the right edge of the position detection pattern 92, where black color darkness is lower, and, on the other hand, the reflectance of light becomes higher at the left edge of the position detection pattern 92, where black color darkness is higher.

Thus, by varying the reflectance of light emitted from the light-emitting section 102 depending on the position along the position detection pattern 92, it becomes possible to detect the current position of the paper guide 9. In particular, any given position of the paper guide 9 with respect to the paper feed tray 8 can be detected because the darkness of color in the position detection pattern 92 gradually changes in the direction of movement of the paper guide 9.

It should be noted that in this case the spot size of the light-emitting section 102 of the optical sensor 100 does not need to be set to be either nearly equal to, or greater than, the width dimension N of the position detection pattern 92, as was done in the above-described embodiment. In other words, here, the reflectance of light varies as a result of color darkness variation, and therefore the difference in light reflectance depending on the position along the position detection pattern 92 can be detected regardless of where the light-emitting section 102 emits light on the position detection pattern 92. Such a position detection pattern 92 makes it possible to detect any given position of the paper guide 9.

Other Position Detection Patterns <2>

FIG. 18 illustrates examples of other position detection patterns that can be used as position detection patterns. A first pattern 98A, which has a single right triangle-shaped black region BK, and a second pattern 98B, which has a plurality of right triangle-shaped black regions BK1, BK2, and BK3, are provided here as position detection patterns. Here, the first pattern 98A has a black region BK formed in the shape of a right triangle and a white region WH similarly formed in the shape of a right triangle. The two regions BK, WH have their hypotenuses mutually joined to form the first pattern 98A in the shape of an elongated rectangle.

On the other hand, here, the second pattern 98B has three right triangle-shaped black regions BK1, BK2, and BK3. The black regions BK1, BK2, and BK3 are arranged such that they are mutually separated by spacing apart along the direction of movement of the paper guide 9. Furthermore, in this embodiment, the black regions BK1, BK2, and BK3 vary in size. Here, the size of the black region BK1 is largest, followed by the black region BK2 and then the black region BK3. The black regions BK1, BK2, and BK3 are provided in order for the position of the paper guide 9 to be detected with a higher degree of accuracy.

Namely, since only one right triangle-shaped black region BK is provided in the first pattern 98A, when the position of the paper guide 9 is detected based on the first pattern 98A alone, accurate detection of the lateral width dimensions of the media S may not be possible and it may be difficult to accurately identify the type of the media S in case of media S whose lateral dimensions are not significantly different. Consequently, the position is detected using the second pattern 98B in conjunction with the first pattern 98A.

In order to be able to more accurately distinguish the type of media S whose respective lateral width dimensions are not significantly different, the three black regions BK1, BK2, and BK3 of the second pattern 98B are respectively provided in close proximity to locations corresponding to the lateral width dimensions of these media S. For instance, the black region BK2 is provided for the purpose of more accurately distinguishing between “letter”, “A4”, and “return postcard”. Also, the black region BK2 is provided for the purpose of more accurately distinguishing between “A6”, “postcard”, and “L”. In addition, the black region BK3 is provided for the purpose of more accurately distinguishing between “business card” and “card”. Providing these three black regions BK1, BK2, and BK3 allows for distinguishing the type of the media S having extremely similar lateral width dimensions with a higher degree of accuracy.

It should be noted that the two optical sensors 100A, 100B here are provided integrally with the paper guide 9 for the purpose of performing detection individually for the first pattern 98A and the second pattern 98B.

Additionally, although the explanations provided herein refer to the first pattern 98A and second pattern 98B having right triangle-shaped black regions BK, BK1, BK2, and BK3, instead of the first pattern 98A and second pattern 98B, it is also possible to provide patterns, in which color darkness varies in the direction of movement of the paper guide 9, such as the one explained in FIG. 17.

### Overview of Printing Apparatus (Second Embodiment)

<System Configuration>

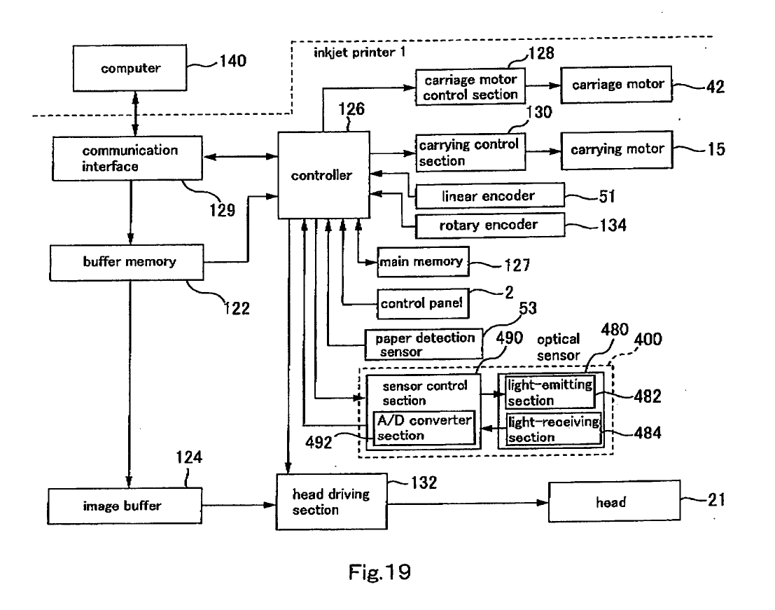

FIG. 19 explains the system configuration of an inkjet printer 1 as an example of the printing apparatus of this embodiment. Here, the inkjet printer 1 has practically the same configuration as the inkjet printer 1 described in the first embodiment. However, as shown in the same diagram, the inkjet printer 1 of this embodiment is provided with a position sensor 400, which detects the position of the paper guide 9. The position sensor 400 is provided with an optical sensor 480 and a sensor control section 490. The configuration of the position sensor 400 is described in detail below.

Configuration of the Paper Feed Unit

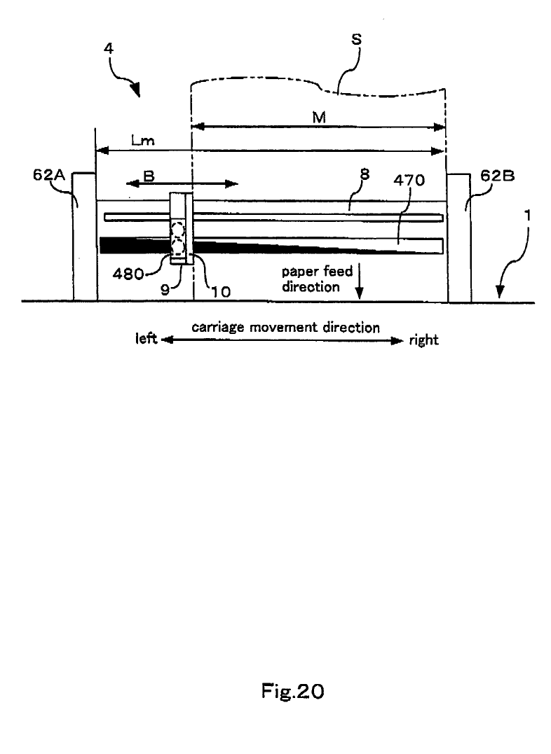

FIG. 20 illustrates the configuration of the paper feed unit 4 of the inkjet printer of this embodiment in detail. As illustrated in FIG. 1, a paper feed tray 8 and a paper guide 9 used for regulating the positional shifting of the media S such as a paper sheet loaded into the paper feed tray 8 are provided in the paper feed unit 4. The media S being printed upon are loaded into the paper feed tray 8. The number of sheets of the media S loaded into the paper feed tray 8 is between one and several dozen sheets. As shown in FIG. 20, protruding sections 62A, 62B are provided along the side edge portions of the paper feed tray 8 (in the feed direction of the media S), on the right and left sides of the paper feed tray 8. The spacing Lm between these two protruding sections 62A, 62B is set in accordance with the maximum size of the media S that the inkjet printer 1 is capable of printing. The media S are loaded between these two protruding sections 62A, 62B.

On the other hand, as shown in the same diagram, the paper guide 9 is provided slidably in the lateral width direction of the paper feed tray 8, i.e. in the direction of arrow B in the diagram. The paper guide 9 is moved so as to match the width dimension M of the media S loaded into the paper feed tray 8. The media S are loaded between the paper guide 9 and one of the protruding sections 62A, 62B of the paper feed tray 8, in this case the protruding section 623 on the right. It should be noted that here the protruding section 62B on the right corresponds to another regulating guide.

The paper guide 9 is disposed in close proximity to the edge of the media S loaded into the paper feed tray 8, in this case in close proximity to the left edge of the media S. During printing, when the media S loaded into the paper feed tray 8 are sent to the printing section, i.e. the platen 14, the paper guide 9 and the protruding section 62B on the right clamp the media S and guide the media S such that no positional shifting of the media S takes place.

The adjustment of the position of the paper guide 9 is carried out by the user. The user grips a tab section 10, which is provided on the paper guide 9, and moves the paper guide 9 so as to position it in the vicinity of the edge of the media S to match the lateral width dimension M of the media S loaded into the paper feed tray 8.

Position Sensor

<Overview of the Sensor>

The inkjet printer 1 of this embodiment is provided with a position sensor 400 used for detecting the current position of the paper guide 9 provided in the paper feed tray 8. As shown in FIG. 20, the position sensor 400 is provided with a position detection pattern 470 and an optical sensor 480, which reads the position detection pattern 470. The position detection pattern 470 is provided on the paper feed tray 8 in order for the position of the paper guide 9 to be detected. The position detection pattern 470 is formed on the top face of the paper feed tray 8 in the shape of a strip in the direction of movement of the paper guide 9, i.e. in the direction of movement of the carriage 41. The position detection pattern 470 is printed on a sheet or a piece of adhesive tape, etc. and attached to the paper feed tray 8 by adhesion, etc.

On the other hand, the optical sensor 480, as shown in the same diagram, is provided on the paper guide 9. The optical sensor 480 is provided facing the position detection pattern 470 and above the position detection pattern 470 provided on the paper feed tray 8. When the paper guide 9 moves, the optical sensor 480 relatively moves in tandem with the paper guide 9 along the position detection pattern 470 and above the position detection pattern 470.

<Configuration of the Optical Sensors>

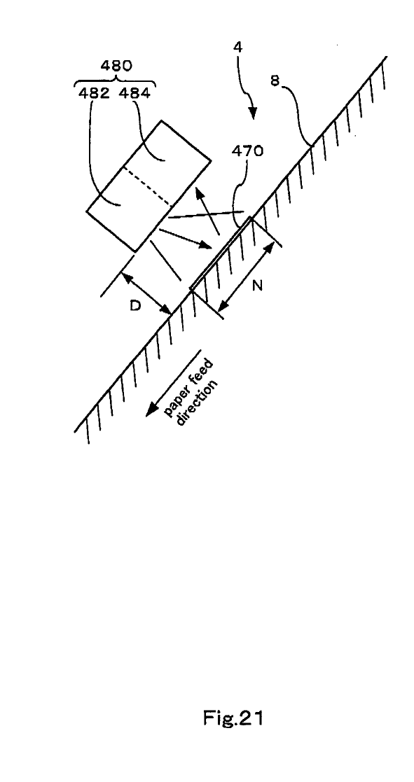

FIG. 21 explains the configuration of the optical sensor 480 in detail. The optical sensor 480 is a reflective optical sensor and, as shown in the same diagram, it is provided with a light-emitting section 482, which emits light, and a light-receiving section 484, which receives light. The light-emitting section 482 and light-receiving section 484 are arranged facing the position detection pattern 470 at a predetermined spacing D from the position detection pattern 470. The light-emitting section 482, which is constituted, for instance, by a light-emitting diode etc., emits light toward the position detection pattern 470. On the other hand, the light-receiving section 484, which is constituted e.g. by a phototransistor etc., receives light reflected by the position detection pattern 470.

The spot size of the light emitted by the light-emitting section 482 is set to be either nearly equal to, or greater than, the longitudinal width dimension N of the position detection pattern 470. As a result, light emitted from the light-emitting section 482 illuminates the entire position detection pattern 470 in its longitudinal width direction. Light reflected from the entire position detection pattern 470 in its longitudinal width direction is incident on the light-receiving section 484.

The light-receiving section 484 generates and outputs a signal corresponding to the intensity of the light incident on said light-receiving section 484. That is, for instance, a high-level signal is generated and outputted when the intensity of the light incident on the light-receiving section 484 is high. Also, for instance, a low-level signal is generated and outputted when the intensity of the light incident on the light-receiving section 484 is low.

The signal generated by the light-receiving section 484 is outputted outside from the optical sensor 480 as a detection signal. In this embodiment, as shown in FIG. 19, the signal generated by the light-receiving section 484 of the optical sensor 480 is outputted from the optical sensor 480 and inputted to a sensor control section 490. The sensor control section 490 then transmits information on the signal generated by the light-receiving section 484 of the optical sensor 480 to the controller 126. The sensor control section 490 is described in detail hereinbelow.

<Position Detection Pattern>

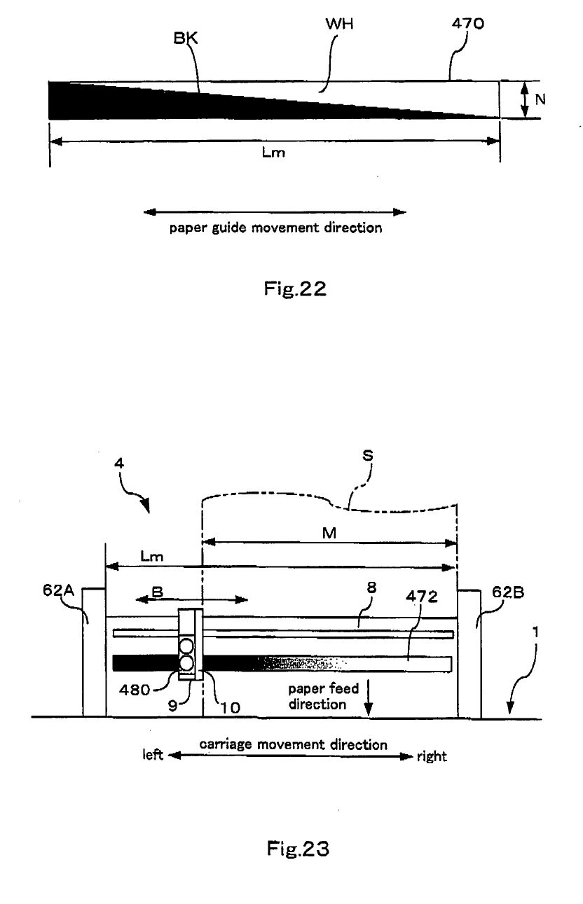

The position detection pattern 470 is described below. FIG. 22 illustrates the position detection pattern 470 in detail. As shown in the same diagram, the position detection pattern 470 of this embodiment has two regions of different colors, i.e. a white region WE formed in the shape of a right triangle and a black region BK similarly formed in the shape of a right triangle. The right triangle-shaped white region WH and black region BK have their hypotenuses mutually joined such that these two right triangle-shaped regions WH and BK form an elongated position detection pattern 470 shaped like a rectangle.

The white region WE is provided such that it tapers off on the left side of the position detection pattern 470. In addition, the black region BK is provided such that it tapers off on the right side of the position detection pattern 470. As a result, the proportion between the white region WH and the black region BK varies in the direction of movement of the paper guide 9. That is, the proportion of the black region BK becomes larger than the proportion of the white region WH in the left portion of the position detection pattern 470. In addition, the proportion of the white region WE becomes larger than the proportion of the black region BK in the right portion of the position detection pattern 470.

Thus, the proportion of the white region WH to the black region BK varies depending on the position along the position detection pattern 470, thereby causing variation in the reflectance of the light emitted from the light-emitting section 482. That is, the reflectance of light becomes lower in the right portion of the position detection pattern 470, where the proportion of the white region WH is larger than the proportion of the black region BK. Also, the reflectance of light becomes higher in the right portion of the position detection pattern 470, where the proportion of the white region WH is larger than the proportion of the black region BK. In other words, the reflectance of light emitted from the light-emitting section 482 gradually decreases in the direction of movement of the paper guide 9 from the right portion of the position detection pattern 470 to its left portion.

In this manner, by varying the reflectance of light emitted from the light-emitting section 482 depending on the position along the position detection pattern 470, it becomes possible to detect the current position of the paper guide 9. That is, since the intensity of the reflected light varies depending on the position along the position detection pattern 470, the position of the paper guide 9 can be detected by determining the intensity of the reflected light.

In particular, any given position of the paper guide 9 with respect to the paper feed tray 8 can be detected because the proportion of the white region WH to the black region BK in the position detection pattern 470 of this embodiment gradually changes in the direction of movement of the paper guide 9.

In addition, since the length Lm of the position detection pattern 470 is set in accordance with the moving range of the paper guide 9, the position of the paper guide 9 can be detected regardless of where it is located.

<Sensor Control Section>

As shown in FIG. 19, drive control over the optical sensor 480 in the inkjet printer 1 of this embodiment is carried out by the sensor control section 490. The sensor control section 490 drives the optical sensor 480 in accordance with commands received from the controller 126. Namely, when a command is issued by the controller 126, the sensor control section 490 causes the light-emitting section 482 of the optical sensor 480 to emit light or to stop emission from the light-emitting section 482. Furthermore, the sensor control section 490 is provided with an A/D converter section 492. The A/D converter section 492 performs conversion of signals outputted from the light-receiving section 484 of the optical sensor 480 from analog signals to digital signals. Specifically, the sensor control section 490 performs A/D conversion of the signal outputted from the optical sensor 480 into a digital signal and outputs it as digital data to the controller 126.

<Processing Executed by the Controller>

The controller 126 detects the current position of the paper guide 9 based on the information transmitted from the sensor control section 490 regarding the intensity of the light received by the light-receiving section 484 of the optical sensor 480. That is, here, the controller 126 determines that as the intensity of the light received by the light-receiving section 484 grows stronger, the paper guide 9 moves to the right side of the paper feed tray 8. On the other hand, the controller 126 determines that as the intensity of the light received by the light-receiving section 484 becomes weaker, the paper guide 9 moves to the left side of the paper feed tray 8.

As a result, the controller 126 can detect the current position of the paper guide 9. Moreover, the controller 126 can detect any given position of the paper guide 9 because, as shown in FIG. 22, the reflectance of the light emitted by the light-emitting section 482 of the optical sensor 480 varies from the right side of the position detection pattern 470 to its left side. It should be noted that the controller 126 of this embodiment corresponds to the detection section.

Another Position Detection Pattern

FIG. 23 explains an example of another type of position detection pattern 472. As shown in the same diagram, the position detection pattern 472 used here is a pattern, in which the darkness of color varies in the direction of movement B of the paper guide 9. Here, black color darkness varies in the direction of movement B of the paper guide 9. In addition, the darkness of color is set so as to gradually increase from the right edge to the left edge of the position detection pattern 472. That is, black color darkness becomes lighter at the right edge of the position detection pattern 472, producing a near-white color. Also, black color darkness becomes darker at the left edge of the position detection pattern 472, producing a near-black color. The gray color becomes gradually darker from the right edge to the left edge of the position detection pattern 472.

In this manner, the darkness of color varies depending on the position along the position detection pattern 472 in the direction of movement of the paper guide 9, thereby causing variation in the reflectance of the light emitted from the light-emitting section 482. In other words, here, the reflectance of light is lower at the right edge of the position detection pattern 472, where black color darkness is lower, and, on the other hand, the reflectance of light becomes higher at the left edge of the position detection pattern 472, where black color darkness is higher.

In this manner, by varying the reflectance of light emitted from the light-emitting section 482 depending on the position along the position detection pattern 472, it becomes possible to detect the current position of the paper guide 9. In particular, any given position of the paper guide 9 with respect to the paper feed tray 8 can be detected because the darkness of color in the position detection pattern 472 gradually changes in the direction of movement of the paper guide 9.

It should be noted that in this case the spot size of the light-emitting section 482 of the optical sensor 480 does not need to be set to be either nearly equal to, or greater than, the width dimension N of the position detection pattern 472, as was done in the above-described embodiment. In other words, here, the reflectance of light varies as a result of color darkness variation, and therefore the difference in light reflectance depending on the position along the position detection pattern 472 can be detected regardless of where the light-emitting section 482 emits light on the position detection pattern 472. With such a position detection pattern 472, it is possible to detect any given position of the paper guide 9.

Processing Executed by the Controller, etc.

The controller 126 acquires information on the current position of the paper guide 9 from the position sensor 400 based on instructions from the externally connected computer 140. The controller 126 then transmits the information acquired from the position sensor 400 to the computer 140. The computer 140 executes print processing based on the information on the current position of the paper guide 9 acquired from the controller 126.

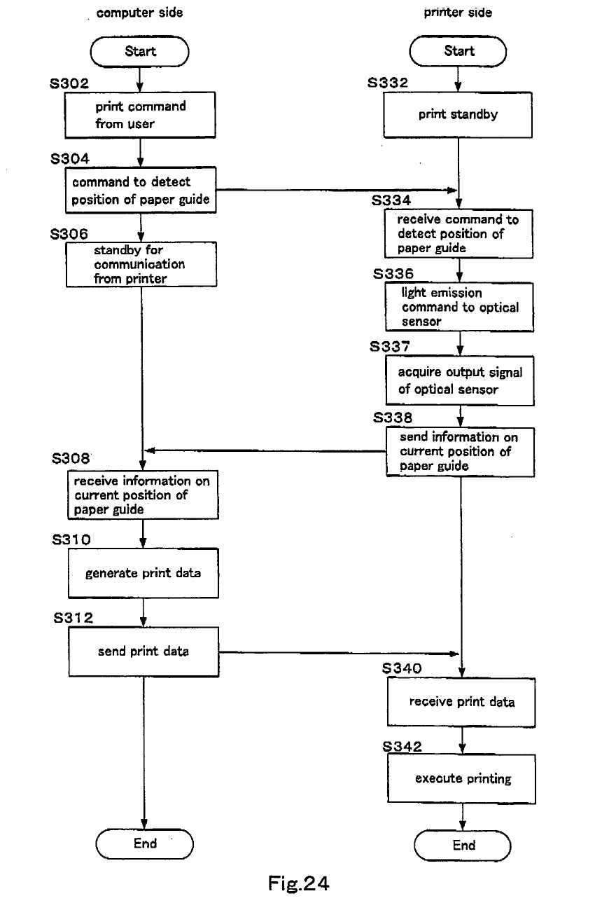

FIG. 24 explains an example of a series of interactions between the controller 126 and the computer 140. When a print command is issued by the user (S302), the computer 140 issues a command for the inkjet printer 1 to detect the position of the paper guide 9 (S304).

Upon receipt of the command to detect the position of the paper guide 9 from the computer 140 (S334) while in a print standby state (S332), the controller 126 of the inkjet printer 1 issues a command to the sensor control section 490 to cause the light-emitting section 482 of the optical sensor 480 to emit light (S336). As a result, light is emitted toward the position detection pattern 470 or 472 from the light-emitting section 482 of the optical sensor 480. In addition, light reflected by the position detection pattern 470 or 472 is received by the light-receiving section 484 of the optical sensor 480. The optical sensor 480 outputs a signal corresponding to the intensity of the light received by the light-receiving section 484 to the sensor control section 490. The sensor control section 490 converts the signal obtained from the optical sensor 480 into digital data using the A/D converter section 492 and transmits it to the controller 126.

The controller 126 acquires information on the intensity of the light received by the light-receiving section 484 of the optical sensor 480 via the sensor control section 490 (S337). The controller 126 then acquires information on the current position of the paper guide 9 from the information on the intensity of light received by the light-receiving section 484 of the optical sensor 480 and sends this information to the computer 140 (S338).

The computer 140 receives information regarding the current position of the paper guide 9 from the inkjet printer 1 (S308). The computer 140 then generates print data based on the received information (S310). Here, the computer 140 acquires information on the size of the media S actually loaded into the paper feed tray 8 from the information on the current position of the paper guide 9 supplied from the inkjet printer 1 and generates print data that permits images be printed so as to match the size of the media S to be printed upon. The computer 140 sends the generated print data to the inkjet printer 1 (S312).

Upon receiving the print data from the computer 140 (S340), at first, the controller 126 of the inkjet printer 1 performs print processing (S342) based on the received print data and carries out printing on the media S.

Relationship Between Size and Lateral Width Dimensions of Media

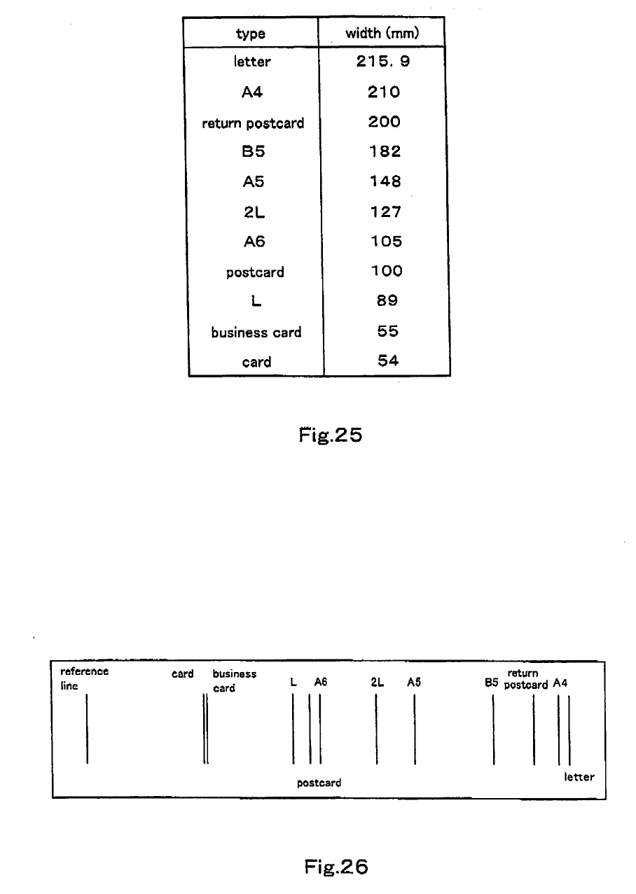

FIG. 25 specifically illustrates various standard sizes of media S and their lateral width dimensions. FIG. 26 specifically illustrates the relationship of the lateral width dimensions of various media S. Here, the medium of the largest size is “letter”. Starting from the “letter” size, the lateral width dimensions become successively smaller in the following order: “A4”, “return postcard”, “A5”, “A5”, “2L”, “A6”, “postcard”, “L”, “business card”, and “card”. Thus, the type of the media S can be distinguished by detecting the lateral width dimensions, because the lateral width dimensions vary depending on the type of the media S.

Moreover, in the inkjet printer 1 of this embodiment, the position sensor 400 is capable of detecting any given position of the paper guide 9. Accordingly, it is possible to accurately detect the position of the paper guide 9 and allow for the type of the media S to be distinguished relatively easily even in case of media whose lateral width dimensions are not particularly different, such as, for instance, “letter” and “A4”, “A4” and “post-card”, “A6” and “post-card”, “business card” and “card”.

It should be noted that processing for distinguishing the type of the media S based on the detection results received from the position sensor 406 can be carried out by the controller 126 of the inkjet printer 1 or by the externally connected computer 140.

Summary

In the inkjet printer 1 of the above embodiment, the position of the regulating guide 9 can be detected in a contactless manner by providing a position sensor 400 on the paper feed tray 8 for detecting the position of the paper guide 9, with said sensor constituted by a position detection pattern 470, 472 and an optical sensor 480, which reads the position detection pattern 470, 472. As a result, the size of the media S loaded into the paper feed tray 8 can be checked prior to printing and, at the same time, accurate detection of the size of the media S is made possible over an extended period of time.

Also, in this embodiment, any given position of the regulating guide with respect to the paper feed tray 8 can be detected with a high degree of accuracy because a position detection pattern 470 is provided, in which the reflectance of light emitted from the light-emitting section 82 of the optical sensor 480 varies in the direction of movement of the paper guide 9.

In addition, since any given position of the paper guide 9 can be detected in this embodiment, it is possible to easily distinguish even media whose lateral width dimensions are not particularly different, such as, for instance, “letter” and “A4”, “A4” and “post-card”, “A6” and “post-card”, “business card” and “card”, etc.

Additionally, in this embodiment, using the position sensor 400 to check the size of the media S loaded into the paper feed tray 8 in advance, prior to printing, allows for generating print data in accordance with the size of the media S to be printed on. Thus, even if the size of the media S set by the user is different from the size of the actual media to be printed on, print processing can be executed appropriately for the size of the actual media S to be printed upon.

Configuration of Another Paper Feed Unit

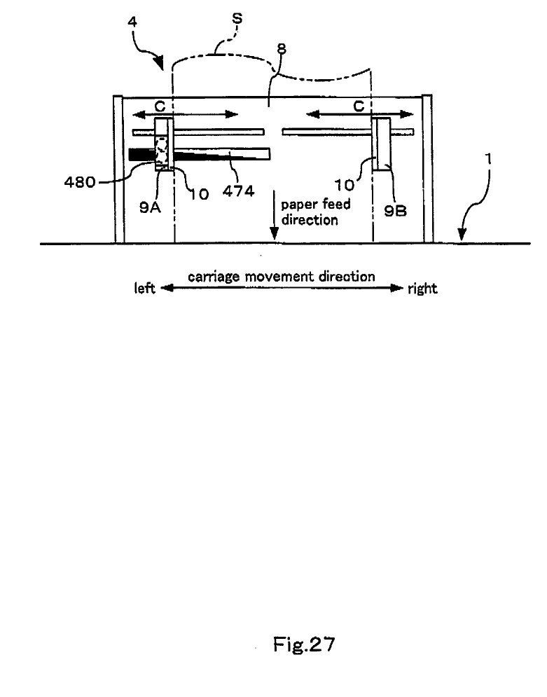

FIG. 27 is a diagram explaining the configuration of another paper feed unit 4. Here, a paper feed tray 8 and paper guides 9A, 9B are provided in the paper feed unit 4. The media S being printed upon are loaded into the paper feed tray 8. The paper guides 9A, 9B are provided for the purpose of regulating the positional shifting of the media S such as a paper sheet loaded into the paper feed tray 8. The media S are loaded between the two paper guides 9A, 9B. The two paper guides 9A, 9B clamp the media S loaded into the paper feed tray 8 from the right and left sides and, during printing, when the media S are sent to the printing section, i.e. the platen 14, they guide the media S such that no positional shifting of the media S takes place. It should be noted that either one of these two paper guides 9A, 9B corresponds to the regulating guide, with the other one corresponding to another regulating guide.

Also, as shown in the same diagram, the two paper guides 9A, 9B are provided slidably in the lateral width direction of the paper feed tray 8, i.e. in the direction of arrow C in the diagram. The two paper guides 9A, 9B are configured to move in the direction of arrow C in the diagram in a mutually interlocked fashion. Namely, movement of one of the paper guides 9A results in interlocked movement of the other paper guide 9B. That is, a mechanism, not shown, which causes the two paper guides 9A, 9B to move in a mutually interlocked fashion is provided in the rear portion etc. of the paper feed tray 8. Here, when one of the paper guides 9A moves in the direction away from the other paper guide 9B, the other paper guide 9B also moves in an interlocked fashion in the direction away from the first paper guide 9A. Also, when one of the paper guides 9A moves in the direction toward the other paper guide 9B, the other paper guide 9B also moves in an interlocked fashion in the direction toward the first paper guide 9A. As a result, the media S loaded into the paper feed tray 8 can be always loaded in the center of the paper feed tray 8.

Thus, providing two slidable paper guides 9A, 9B permits acquisition of the lateral width dimensions of the media S loaded into the paper feed tray 8 by detecting the position of at least one of the two paper guides 9A, 9B. Here, the optical sensor 480 is provided on the paper guide 9A on the left for the purpose of detecting the position of that paper guide 9A. In addition, a position detection pattern 474 is provided facing the optical sensor 480 on the paper feed tray 8 in the direction of movement of said paper guide 9A. This makes it possible to distinguish the size and type of the media S.

Another Position Detection Pattern <1>

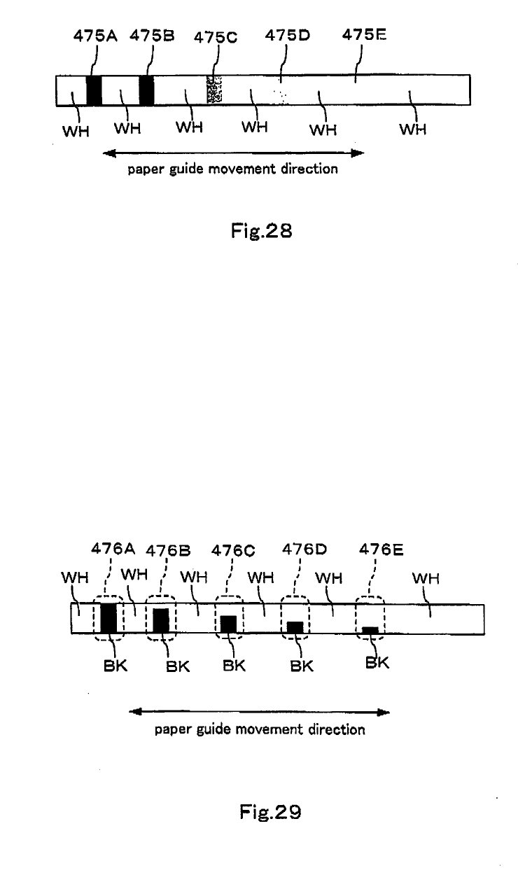

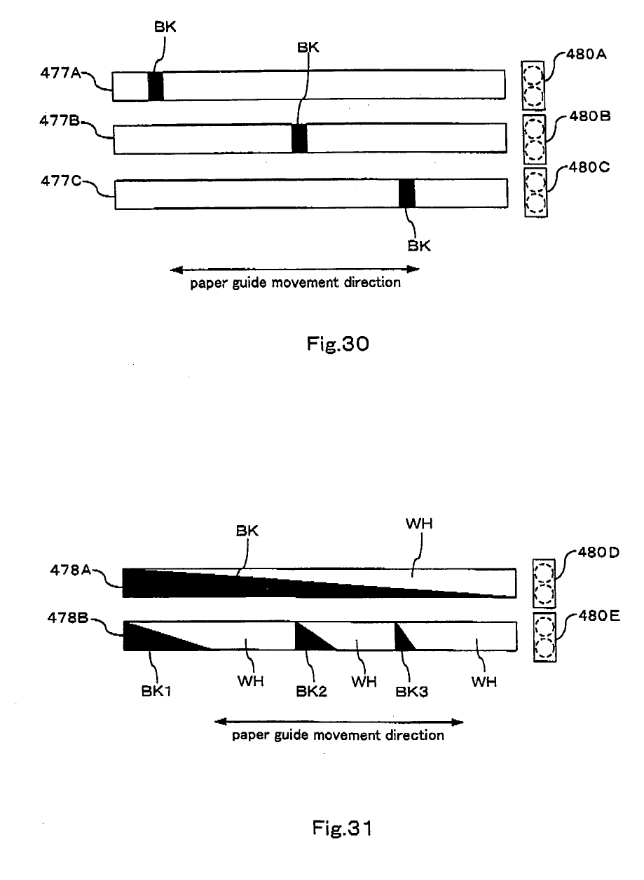

FIGS. 28-30 respectively illustrate examples of other position detection patterns that can be used as position detection patterns. FIG. 28 illustrates a case in which the apparatus is provided with a plurality of patterns 475A, 475B, 475C, 475D, 475E each having a different color darkness. FIG. 29 illustrates a case in which the apparatus is provided with a plurality of patterns 476A, 476B, 476C, 476D, and 476E having respectively different lengths of the black regions BK in the longitudinal direction. FIG. 30 illustrates a case in which the apparatus is provided with a plurality of patterns 477A, 477B, and 477C, whose respective black regions BK are provided in different locations.

Among the plurality of patterns 475A, 475B, 475C, 475D, and 475E shown in FIG. 28, patterns 475A and 475B have a high color darkness and patterns 475D and 475E have a low color darkness. Here, the patterns 475A, 475B, 475C, 475D, and 475E are arranged such that they are mutually separated by spacing apart in the direction of movement of the paper guide 9. The patterns 475A, 475B, 475C, 475D, and 475E provide different reflectance for light emitted from the light-emitting section 482. In other words, the reflectance of light is lowest in pattern 475A, where black color darkness is highest, and, on the other hand, the reflectance of light is highest in pattern 475E, where black color darkness is lightest. White regions WH are provided between the patterns 475A, 475B, 475C, 475D, and 475E.

When positioned above one of the plurality of patterns 475A, 475B, 475C, 475D, and 47SE, the optical sensor 480 provided on the paper guide 9 can read the pattern. Because the color darkness of each of the patterns 475A, 475B, 475C, 475D, and 475E is different, the intensity of the light received by the light-receiving section 484 of the optical sensor 480 varies as well. Accordingly, by checking the intensity of the light received by the light-receiving section 484 of the optical sensor 480, it is possible to determine the pattern above which the optical sensor 480 is positioned. This permits detection of the current position of the paper guide 9. It should be noted that the position of the paper guide 9 cannot be detected when the optical sensor 480 is positioned above a white region WH.

By dispersedly providing the patterns 475A, 475B, 475C, 475D, and 475E in locations where the paper guide would be set when media S of a standard size are loaded into the paper feed tray 8, it becomes possible easily confirm the type of media S loaded into the paper feed tray 8.

It should be noted that in this case the spot size of the light-emitting section 482 of the optical sensor 480 does not need to be set to be either nearly equal to, or greater than, the width dimension N of the patterns 475A, 475B, 475C, 475D, and 475E, as was done in the above-described embodiment.

Among the plurality of patterns 476A, 476B, 476C, 476D, and 476E shown in FIG. 29, pattern 476E has a black region BK of insignificant length in the longitudinal direction while pattern 476A has a black region BK of significant length in the longitudinal direction. The patterns 476A, 476B, 476C, 476D, and 476E are arranged such that they are mutually separated by spacing apart in the direction of movement of the paper guide 9. The spot size of the light-emitting section 482 of the optical sensor 480 is set to be either nearly equal to, or greater than, the width dimension N of the patterns 476A, 476B, 476C, 476D, and 476E. For this reason, when light is emitted from the light-emitting section 482 of the optical sensor 480 toward the patterns 476A, 476B, 476C, 476D, and 476E, the reflectance of the light in each of the pattern 476A, 476B, 476C, 476D, and 476E is different. Namely, the reflectance of light is lowest in pattern 476A, where the length of the black region BK in the longitudinal direction is largest, and, on the other hand, the reflectance of light is highest in pattern 476E, where the length of the black region BK in the longitudinal direction is smallest. White regions WE are provided between the patterns 476A, 476B, 476C, 476D, and 476E.

When positioned above one of the plurality of patterns 476A, 476B, 476C, 476D, and 476E, the optical sensor 480 provided on the paper guide 9 can read this pattern. Namely, since the respective reflectance of light emitted from the light-emitting section 482 in each of the patterns 476A, 476B, 476C, 476D, and 476E is different, the pattern, above which the optical sensor 480 is positioned, can be determined by determining the intensity of the light received by the light-receiving section 484 of the optical sensor 480. This permits detection of the current position of the paper guide 9. It should be noted that the position of the paper guide 9 cannot be detected when the optical sensor 480 is positioned above a white region WH.

Among the plurality of patterns 477A, 477B, and 477C shown in FIG. 30, pattern 477A has a black region BK arranged on the left-hand side, pattern 477B has a black region BK arranged in the middle portion, and pattern 477C has a black region BK arranged on the right-hand side.

Here, optical sensors 480A, 480B, and 480C are provided respectively facing each of the patterns 477A, 477B, and 477C. In other words, pattern 477A, in which the black region BK is arranged on the left-hand side, is provided with a single optical sensor 480A corresponding to that pattern 447A, and pattern 477C, in which the black region BK is arranged on the right-hand side, is also provided with a single optical sensor 480C corresponding to that pattern 447C. The optical sensors 480A, 480B, and 480C are provided integrally with a single paper guide 9.

The position of the paper guide 9 can be detected if any one of the optical sensors 480A, 480B, and 480C is positioned above a black region BK of the patterns 477A, 477B, and 477C corresponding thereto as a result of movement of the paper guide 9. Namely, for instance, if the optical sensor 480A is positioned above the black region BK of the corresponding pattern 477A, the intensity of the light received by the light-receiving section 484 changes. As a result, it is confirmed that the optical sensor 480A is positioned above the black region BK of the pattern 477A and, therefore, the position of the paper guide 9 can be detected.

It should be noted that here the position of the paper guide 9 cannot be detected if any one of the optical sensors 480A, 480B, and 480C is not positioned above one of the black regions BK of the patterns 477A, 477B, and 477C.

Other Position Detection Patterns <2>

FIG. 31 illustrates examples of other position detection patterns that can be used as position detection patterns. A first pattern 478A, which has a single right triangle-shaped black region BK, and a second pattern 478B, which has a plurality of right triangle-shaped black regions BK1, BK2, and BK3, are provided here as position detection patterns. Here, the first pattern 478A has a black region BK formed in the shape of a right triangle and a white region WH similarly formed in the shape of a right triangle. These two regions BK, WH have their hypotenuses mutually joined to form the first pattern in the shape of an elongated rectangle.

On the other hand, here, the second pattern 478B has three right triangle-shaped black regions BK1, BK2, and BK3. The black regions BK1, BK2, and BK3 are arranged such that they are mutually separated by spacing apart along the direction of movement of the paper guide 9. Furthermore, in this embodiment, the black regions BK1, BK2, and BK3 vary in size. Here, the size of the black region BK1 is largest, followed by the black region BK2 and then the black region BK3. The black regions BK1, BK2, and BK3 are provided in order for the position of the paper guide 9 to be detected with a higher degree of accuracy.

Namely, since only one right triangle-shaped black region BK is provided in the first pattern 478A, when the position of the paper guide 9 is detected based on the first pattern 478A alone, accurate detection of the lateral width dimensions of the media S may not be possible and it may be difficult to accurately identify the type of the media S in case of media S whose lateral dimensions are not significantly different. Thus, the position is detected using the second pattern 478B in addition to the first pattern 478A.

In order to be able to more accurately distinguish the type of media S whose respective lateral width dimensions are not significantly different, the three black regions BK1, BK2, and BK3 of the second pattern 478B are respectively provided in the vicinity of locations corresponding to the lateral width dimensions of such media S. For instance, the black region BK1 is provided for the purpose of more accurately distinguishing between “letter”, “A4”, and “return postcard”. Also, the black region BK2 is provided for the purpose of more accurately distinguishing between “A6”, “postcard”, and “L”. In addition, the black region BK3 is provided for the purpose of more accurately distinguishing between “business card” and “card”. Providing these three black regions BK1, BK2, and BK3 allows for distinguishing the type of the media S having extremely similar lateral width dimensions with a higher degree of accuracy.

It should be noted that, here, two optical sensors 480D, 480E are provided integrally with the paper guide 9 for the purpose of performing detection individually for the first pattern 478A and the second pattern 478B.

Additionally, although the explanations herein refer to the first pattern 478A and second pattern 478B having right triangle-shaped black regions BK, BK1, BK2, and BK3, instead of the first pattern 478A and second pattern 478B, patterns can be provided in which color darkness varies in the direction of movement of the paper guide 9, such as the one explained in FIG. 23.

### Overview of Printing Apparatus (Third Embodiment)

<System Configuration>

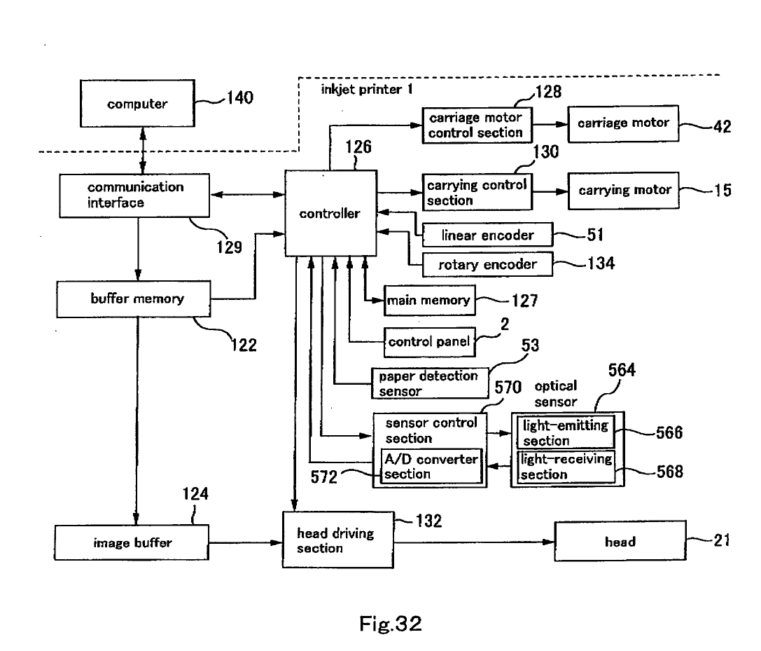

FIG. 32 explains the system configuration of an inkjet printer used as an example of the printing apparatus of this embodiment. Here, the inkjet printer 1 has practically the same configuration as the inkjet printer 1 described in the first embodiment. However, as shown in the same diagram, the inkjet printer 1 of this embodiment is provided with an optical sensor 564 (corresponding to the “sensor”), which is used for confirming whether or not there are media S in the vicinity of the paper guide 9, and a sensor control section 570, which exercises drive control over the optical sensor 564. The optical sensor 564 and the sensor control section 570 are described in detail below.

Configuration of the Paper Feed Unit

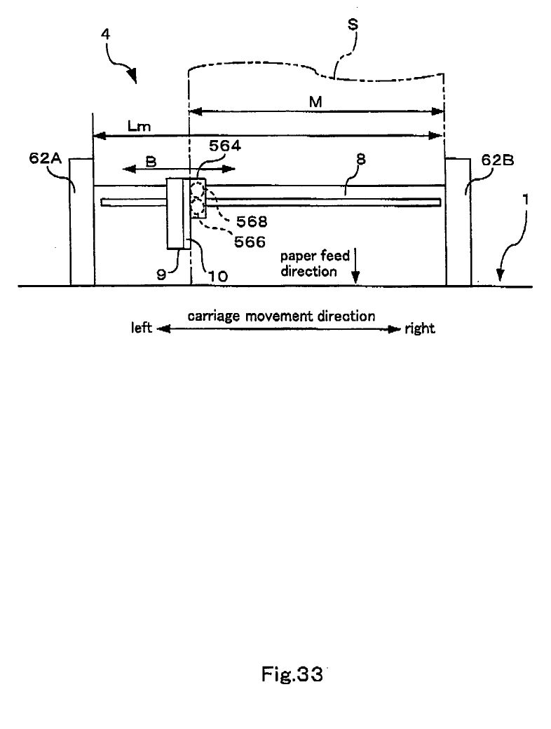

FIG. 33 illustrates the configuration of the paper feed unit 4 of the inkjet printer of this embodiment in detail. As illustrated in FIG. 1, a paper feed tray 8 and a paper guide 9 used for regulating the positional shifting of the media S such as a paper sheet loaded into the paper feed tray 8 are provided in the paper feed unit 4. The media S being printed upon are loaded into the paper feed tray 8. The number of sheets of the media S loaded into the paper feed tray 8 is between one and several dozen sheets. As shown in FIG. 33, protruding sections 62A, 62B are provided along the side edge portions of the paper feed tray 8 (in the feed direction of the media S), on the right and left sides of the paper feed tray 8. The spacing Lm between these two protruding sections 62A, 62B is set in accordance with the maximum size of the media S that the inkjet printer 1 is capable of printing. The media S are loaded between these two protruding sections 62A, 62B.

On the other hand, as shown in the same diagram, the paper guide 9 is provided slidably in the lateral width direction of the paper feed tray 8, i.e. in the direction of arrow B in the diagram. It should be noted that the paper guide 9 corresponds to a “movable guide”. The paper guide 9 is moved so as to match the width dimension M of the media S loaded into the paper feed tray 8. The media S are loaded between the paper guide 9 and one of the protruding sections 62A, 62B of the paper feed tray 8, in this case the protruding section 62B on the right. It should be noted that here the protruding section 62B on the right corresponds to a fixed guide”.

The paper guide 9 is disposed in close proximity to the edge of the media S loaded into the paper feed tray 8, in this case in close proximity to the left edge of the media S. During printing, when the media S loaded into the paper feed tray 8 are sent to the printing section, i.e. the platen 14, the paper guide 9 and the protruding section 62B on the right clamp the media S and guide the media S such that no positional shifting of the media S takes place.

The adjustment of the position of the paper guide 9 is carried out by the user. The user grips a tab section 10, which is provided on the paper guide 9, and moves the paper guide 9 so as to position it in the vicinity of the edge of the media S to match the lateral width dimension M of the media S loaded into the paper feed tray 8.

Optical Sensor

<Overview of the Sensor>

As shown in FIG. 33, the inkjet printer 1 of this embodiment is provided with an optical sensor 564 used for confirming whether or not there are media S in the vicinity of the paper guide 9. It should be noted that the optical sensor 564 corresponds to the “sensor”. In this embodiment, the optical sensor 564, which is provided integrally with the paper guide 9, is provided on the right side portion of the paper guide 9, which is in close proximity to the edge of the media S, in such a manner that it protrudes toward the side of the media S. As a result, the optical sensor 564 is positioned above the edge (in this case, the left edge) of the media S when the media S are loaded between the paper guide 9 and the protruding section 62B on the right side of the paper feed tray 8 as shown by the chain double-dashed line in the same diagram.

In addition, following the movement of the paper guide 9, the optical sensor 564 moves in the width direction B (also called the “carriage movement direction”) of the media S relative to the paper feed tray 8 along with the paper guide 9. Thus, even if the paper guide 9 is moved, the optical sensor 564 will always come above the edge of the media S so long as the paper guide 9 is in close proximity to the media S.

<Configuration of the Optical Sensor>

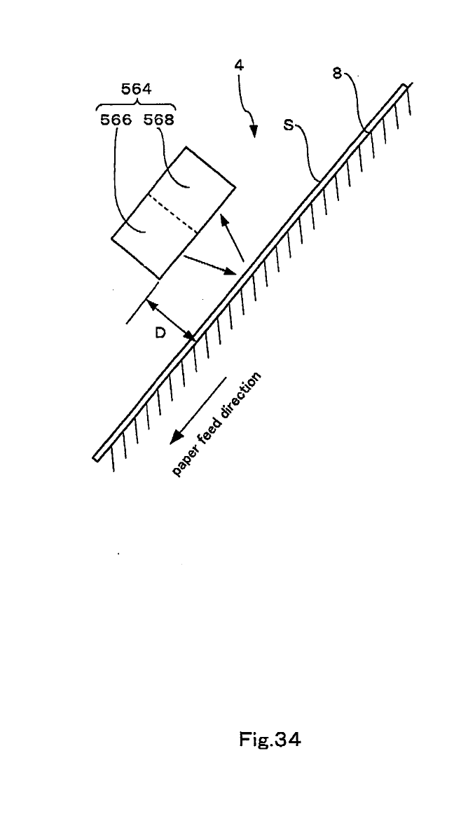

FIG. 34 explains the configuration of the optical sensor 564 in detail. The optical sensor 564 is a reflective optical sensor and, as shown in the same diagram, it is provided with a light-emitting section 566, which emits light, and a light-receiving section 568, which receives light. The light-emitting section 566 and the light-receiving section 568 are arranged such that they are spaced a predetermined spacing D from the paper feed tray B. Then, when media S are loaded between the paper guide 9 and the protruding section 62B on the right side of the paper feed tray 8, media S are inserted between the optical sensor 564 and the paper feed tray 8. As a result, the optical sensor 564 faces the media S.

The light-emitting section 566, which is constituted, for instance, by a light-emitting diode etc., emits light toward the media S. On the other hand, the light-receiving section 568, which is constituted e.g. by a phototransistor etc., receives light reflected by the media S.

The light-receiving section 568 generates and outputs a signal corresponding to the intensity of the light incident on the light-receiving section 568. That is, for instance, a high-level signal is generated and outputted when the intensity of the light incident on the light-receiving section 568 is high. Also, for instance, a low-level signal is generated and outputted when the intensity of the light incident on the light-receiving section 568 is low.

The signal generated by the light-receiving section 568 is outputted outside from the optical sensor 564 as a detection signal. In this embodiment, as shown in FIG. 32, the signal generated by the light-receiving section 568 of the optical sensor 564 is outputted from the optical sensor 564 to a sensor control section 570. The sensor control section 570 then transmits information on the level of the signal generated by the light-receiving section 568 of the optical sensor 564 to the controller 126. <Sensor Control Section>

As shown in FIG. 32, drive control over the optical sensor 564 in the inkjet printer 1 of this embodiment is carried out by the sensor control section 570. The sensor control section 570 exercises drive control over the optical sensor 564 in accordance with commands received from the controller 126. Namely, when a command is issued by the controller 126, the sensor control section 570 causes the light-emitting section 566 of the optical sensor 564 to emit light or to stop emission from the light-emitting section 566. Furthermore, the sensor control section 570 is provided with an A/D converter section 572. The A/D converter section 572 performs conversion of signals outputted from the light-receiving section 568 of the optical sensor 564 from analog signals to digital signals. Specifically, the sensor control section 570 performs A/D conversion of the signal outputted from the optical sensor 564 into digital data and outputs it to the controller 126 as information on the level of the signal generated by the light-receiving section 568 of the optical sensor 564.

<Processing Executed by the Controller>

The controller 126 acquires information regarding the intensity of the light received by the light-receiving section 568 of the optical sensor 564 from the information transmitted from the sensor control section 570. Based on the acquired information, the controller 126 then makes a determination as to whether or not media S have been detected by the optical sensor 564. Here, based on whether or not the level of the signal outputted from the optical sensor 564 has reached a predetermined level, the controller 126 makes a determination as to the presence/absence of detection of media S. That is, for instance, when the level of the signal outputted from the optical sensor 564 reaches a predetermined value, the controller 126 determines that media S have been detected by the optical sensor 564. Also, if the level of the signal outputted from the optical sensor 564 does not reach the predetermined level, the controller 126 determines that media S have not been detected by the optical sensor 564.

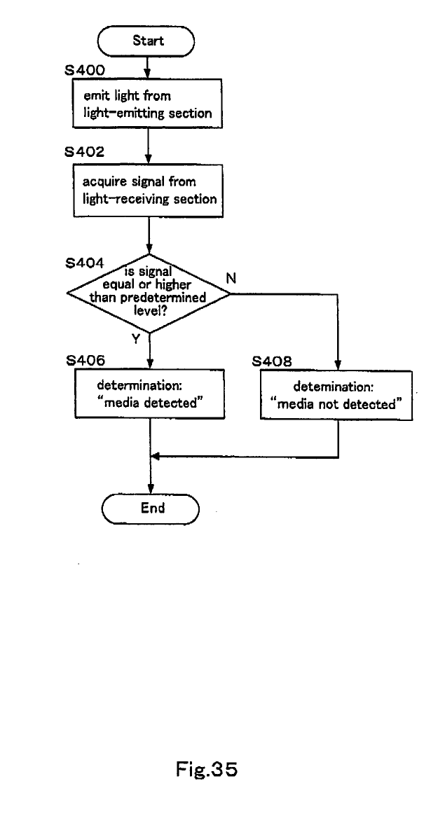

FIG. 35 is a flowchart explaining an exemplary processing procedure of the controller 126. First of all, the controller 126 issues a command to the sensor control section 570 to direct the light-emitting section 566 of the optical sensor 564 to emit light (S400). In accordance with the command received from the controller 126, the sensor control section 570 directs the light-emitting section 566 of the optical sensor 564 to emit light. In addition, the sensor control section 570 acquires a signal corresponding to the relative intensity of the light received by the light-receiving section 568 at such time from the optical sensor 564. The sensor control section 570 then transmits information on the level of the signal outputted from the optical sensor 564 to the controller 126. The controller 126 then acquires information regarding the level of the signal outputted from the optical sensor 564 from the sensor control section 570 (S402).

Based on the information regarding the level of the signal outputted from the optical sensor 564, the controller 126 then makes a determination as to whether or not media S have been detected by the optical sensor 564. Here, the controller 126 makes a determination according to whether or not the level of the signal outputted from the optical sensor 564 has reached the predetermined level (S404). Namely, if the level of the signal outputted from the optical sensor 564 is equal to or higher than the predetermined reference level, the controller 126 determines that media S have been detected by the optical sensor 564 (S406). In other words, the controller 126 determines that the paper guide 9 is positioned in the correct location, i.e. in close proximity to the edge of the media S. On the other hand, if the level of the signal outputted from the optical sensor 564 is less than the predetermined level, the controller 126 determines that media S have not been detected by the optical sensor 564 (S408). In other words, the controller 126 determines that the paper guide 9 is positioned in the correct location, i.e. in close proximity to the edge of the media S.

After detecting the presence of media S with the help of the optical sensor 564 based on the signal outputted from the light-receiving section 568 of the optical sensor 564, the controller 126 terminates processing.

<Regarding the Media Detection Range>

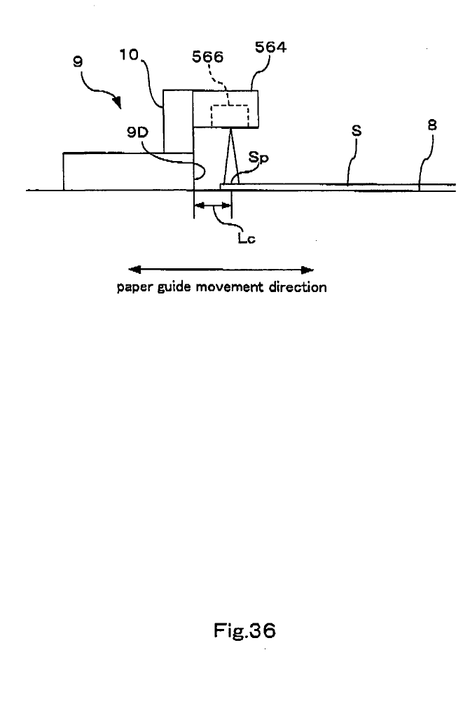

FIG. 36 explains the range within which media S can be detected by the optical sensor 564. As shown in the same diagram, the optical sensor 564 is provided integrally with the top portion of the tab section 10 of the paper guide 9, protruding from the top portion toward the side of the media S, i.e. on the right side in the figure. A predetermined spacing D is left between the optical sensor 564 and the top face of the paper feed tray 8, with the optical sensor 564 arranged facing the paper feed tray S. As shown in the same diagram, light emitted from the light-emitting section 566 of the optical sensor 564 is emitted from said light-emitting section 566 downward toward the media S (the top face of the paper feed tray 8). A spot Sp of light emitted from the light-emitting section 566 of the optical sensor 564 is formed on the media S. The spot Sp is formed at a position slightly spaced away from the surface 9D of the paper guide 9 abutting the media S (the right side portion).

As a result, the media S is detected by the optical sensor 564, even if the edge of the media S is located at a certain distance from the abutting surface 9D of the paper guide 9 (the right side portion). Namely, the media S is detected by the optical sensor 564 even if the paper guide 9 is not completely in contact with the edge of the media S. This is due to the fact that the paper guide 9 does not necessarily have to be in close contact with the edge of the media S. In other words, this is because the positional shifting of the media S can be sufficiently regulated by the paper guide 9 even if the paper guide 9 is somewhat spaced away from the edge of the media S. So long as the positional shifting of the media $ can be sufficiently regulated, the objective of the paper guide 9 is achieved.

While the maximum allowable separation distance Lc between the paper guide 9 and the edge of the media S that is necessary for the paper guide 9 to regulate the positional shifting of the media S varies depending on individual printing apparatuses, in general, however, it is preferably set in the range of from not less than 1 mm and not more than 10 mm.

The optical sensor 564 merely needs to detect whether or not media S are present within this maximum allowable separation distance Lc. That is, this maximum allowable separation distance Lc corresponds to the “predetermined distance”. The maximum allowable distance Lc serves as a criterion for detecting the presence of media S using the optical sensor 564. The media S are detected by the optical sensor 564 when the distance between the paper guide 9 and media S is smaller than the maximum allowable separation distance LC. On the other hand, when the gap between the paper guide 9 and media S is greater than the maximum allowable separation distance Lc, the media S are not detected by the optical sensor 564.

The following techniques can be used for setting the range of detection of media S with the help of the optical sensor 564.

(1) Adjusting the position of the optical sensor 564. For instance, adjusting the distance between the optical sensor 564 and the surface 9D of the paper guide 9 abutting the media S.

(2) Adjusting the diameter of the spot Sp of light emitted from the light-emitting section 566 of the optical sensor 564. Reducing the diameter of the spot Sp narrows down the range of detection of the media S by the optical sensor 564 and, on the other hand, increasing the diameter of the spot Sp widens the range of detection of the media S by the optical sensor 564.

(3) Using controller 126 to adjust the predetermined reference level serving as the criterion of presence of media S. In this case, when the predetermined reference level is increased, the predetermined distance serving as the criterion for determination (corresponding to the “predetermined distance”) can be narrowed down. Also, when the predetermined reference level is decreased, the predetermined distance serving as the criterion for determination (corresponding to the “predetermined distance”) can be widened.

These methods can be used to appropriately adjust the range of detection of media s by the optical sensor 564. Namely, they allow for appropriately modifying the “predetermined distance” between the paper guide 9 and media S, which serves as the criterion for determining whether or not the paper guide 9 is in close proximity to the edge of the media S.

Computer Processing (1)

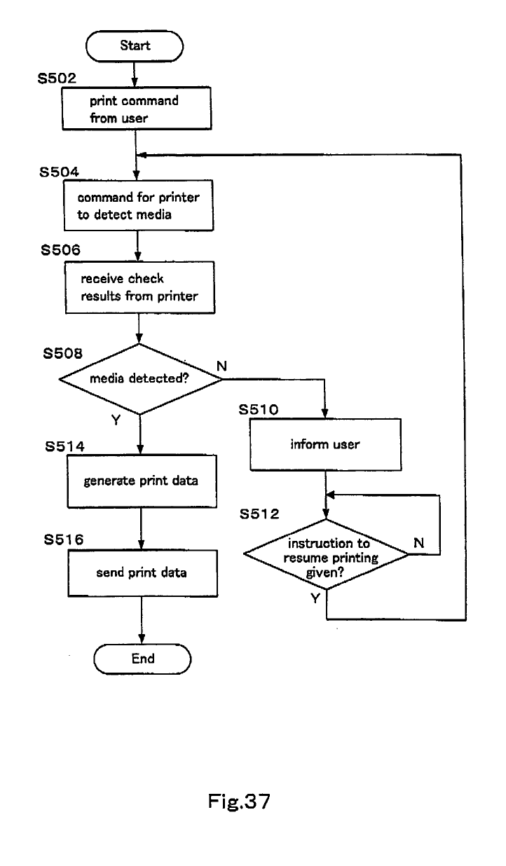

FIG. 37 explains an exemplary processing procedure of the computer 140 at such time. When a print command is issued by the user (S502), the computer 140 issues a command for the inkjet printer 1 to check for presence of media S using the optical sensor 564 (S504).

When the computer 140 issues the command, the controller 126 of the inkjet printer 1 uses the optical sensor 564 to check for presence of media S. The controller 126 then transmits the results of the check to the computer 140. The computer 140 receives the results of the check from the inkjet printer 1 (S506).

The computer 140 then checks whether or not media S have been detected by the optical sensor 564 (S508). Here, if media S have been detected by the optical sensor 564, it determines that the paper guide 9 is in the vicinity of the end of the media S and, assuming that the positional shifting of the media S can be sufficiently regulated by the paper guide 9, generates print data (S514) and sends the print data to the inkjet printer 1 (S516).

On the other hand, if no media S have been detected by the optical sensor 564, the computer determines that the paper guide 9 is not in the vicinity of the edge of the media S and, for this reason, assumes that possibly either the paper guide 9 is not positioned in the vicinity of the edge of the media S or the media S to be printed have not been loaded into the paper feed tray 8 and informs the user accordingly by displaying a message, etc. (S510). The computer 140 then waits for an instruction from the user to restart printing (S512). Here, when a print restart instruction is given by the user, the computer 140 again returns to Step S504 and issues a command to the inkjet printer 1 to check for presence of media S using the optical sensor 564 (S504). In this way, the computer 140 checks whether or not media S have been detected by the optical sensor 564. Until the media S is detected by the optical sensor 564,the computer 140 repeatedly informs the user by displaying a message on screen (5510), etc., and issues a command to the inkjet printer 1 to check for presence of media S using the optical sensor 564 (S504).

Summary

In the above-described inkjet printer 1 of this embodiment, providing an optical sensor 564 for confirmation of whether or not there are media S in the vicinity of the paper guide 9 allows for checking whether or not the positional shifting of the media S can be sufficiently regulated by the paper guide 9. Thus, when printing is carried out on the media S, the positional shifting of the media S can be prevented from occurring.

In addition, in this embodiment, even if the paper guide 9 and the media S are somewhat spaced apart, the media S can still be detected by the optical sensor 564. Accordingly, even if the paper guide 9 is not in close contact with the media S, the determination made is not “media not detected”. Therefore, a certain amount of error in the position of the paper guide 9 set by the user can be tolerated.

In addition, in this embodiment, simple contactless detection of the media S is made possible by the use of the optical sensor 564 as the sensor. As a result, the media S can be detected in a highly accurate manner over an extended period of time.

### Another Configuration Example 1

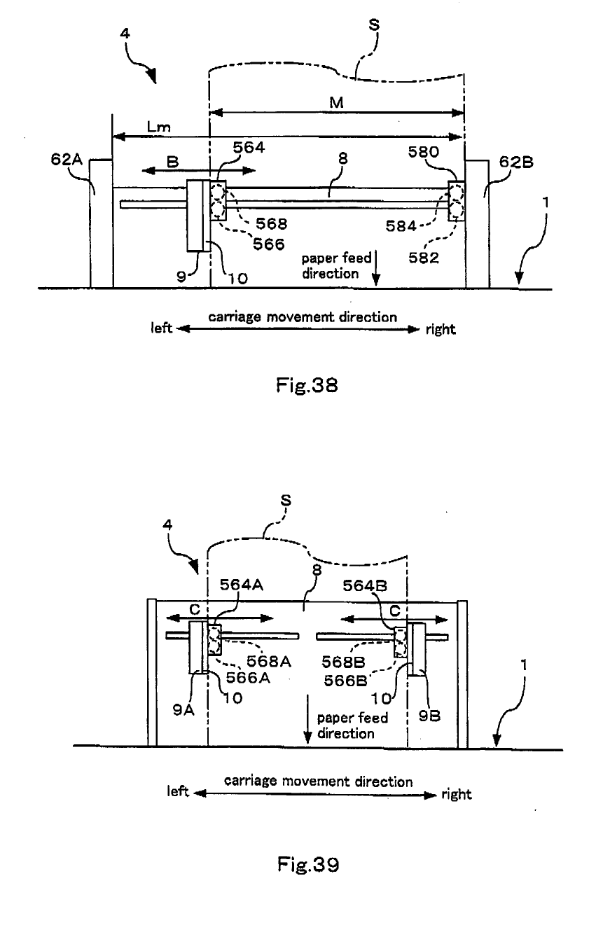

FIG. 38 shows an example, in which an optical sensor 580 is provided on the protruding section 62B on the right side of the paper feed tray 8 in addition to providing optical sensor 564 on the paper guide 9. It should be noted that the protruding section 62B on the right, in the same manner as the paper guide 9, is positioned in close proximity to the edge of the media S, in this case in close proximity to the right edge thereof, and functions as a regulating guide that regulates the positional shifting of the media S (corresponds to the “fixed guide”).

As shown in the same diagram, the optical sensor 580 is provided on the left side portion of the protruding section 62B, protruding from the left side portion towards the media S. A predetermined clearance is left between the optical sensor 580 and the paper feed tray 8, with the optical sensor 580 arranged facing the paper feed tray 8 when media S are loaded between the paper guide 9 and the protruding section 62B, the optical sensor 580 is located above the edge of the media S.

In the same manner as the optical sensor 564 provided on the paper guide 9, the optical sensor 580 is provided with a light-emitting section 582, which emits light, and a light-receiving section 584, which receives light. The light-emitting section 582 and the light-receiving section 584 are arranged facing the media S loaded in the paper feed tray 8. The light-emitting section 582, which is constituted, for instance, by a light-emitting diode etc., emits light toward the media S. In addition, the light-receiving section 584, which is constituted e.g. by a phototransistor etc., receives light reflected by the media S. The light-receiving section 584 generates and outputs a signal corresponding to the intensity of the light incident on the light-receiving section 584.

The signal generated by the light-receiving section 584 is outputted outside from the optical sensor 580 as a detection signal and transmitted to the controller 126 as information on the intensity of light received by the light-receiving section 584.

Based on the information from the optical sensor 580, the controller 126 makes a determination as to whether or not media S have been detected by the optical sensor 580. Here, when the level of the signal outputted from the optical sensor 580 reaches a predetermined value, the controller 126 determines that media S have been detected by the optical sensor 580. In other words, it determines that media S are present in the vicinity of the protruding section 62B. On the other hand, if the level of the signal outputted from the optical sensor 580 does not reach the predetermined level, the controller 126 determines that media S have not been detected by the optical sensor 580. In other words, it determines that there are no media S in the vicinity of the protruding section 62B.

By providing respective optical sensors 580, 564, on the protruding section 62B and on the paper guide 9 regulating the positional shifting of said media S, i.e. on both sides of the media S loaded into the paper feed tray 8, it becomes possible distinguish whether or not media S have been properly loaded between the paper guide 9 and the protruding section 62B.

It should be noted that while here optical sensors 580, 564 are installed both on the paper guide 9 and on the protruding section 62B, providing the optical sensor 580 alone on the protruding section 62B is also possible. In other words, there maybe no optical sensor 564 provided on the paper guide 9.

### Another Configuration Example 2

FIG. 39 is a diagram explaining another configuration of the paper feed unit 4. Here, a paper feed tray 8 and paper guides 9A, 9B are provided in the paper feed unit 4. The paper guides 9A, 9B are provided for the purpose of regulating the positional shifting of the media S such as a paper sheet loaded into the paper feed tray 8. The media S are loaded between the two paper guides 9A, 9B. The two paper guides 9A, 9B clamp the media S loaded into the paper feed tray 8 from the right and left sides and, during printing, when the media S are sent to the printing section, i.e. the platen 14, they guide the media S such that no positional shifting of the media S takes place.

Also, as shown in the same diagram, the two paper guides 9A, 9B are provided slidably in the lateral width direction of the paper feed tray 8, i.e. in the direction of arrow C in the diagram. The two paper guides 9A, 9B are configured to move in the direction of arrow C in the diagram in a mutually interlocked fashion. Namely, when one of the paper guides 9A moves, the other paper guide 9B moves as well in an interlocked fashion. That is, a mechanism, not shown, which causes the two paper guides 9A, 9B to move in a mutually interlocked fashion is provided in the rear portion etc. of the paper feed tray S. Here, when one of the paper guides 9A moves in the direction away from the other paper guide 9B, the other paper guide 9B also moves in an interlocked fashion in the direction away from the first paper guide 9A. Also, when one of the paper guides 9A moves in the direction toward the other paper guide 913, the other paper guide 9B also moves in an interlocked fashion in the direction toward the first paper guide 9A. As a result, the media S loaded into the paper feed tray 8 can be always loaded in the center of the paper feed tray 8.

Here, when the apparatus is provided with two slidably provided paper guides 9A, 9B, optical sensors 564A, 564B are provided respectively for each of the paper guides 9A, 9B. As shown in the same diagram, in the same manner as in the above-described cases, the optical sensors 564A, 564B are provided such that they protrude from the sides of the paper guides 9A, 9B toward the side of the media S. The optical sensors 564A, 564B are respectively provided with light-emitting sections 566A, 566B and,light-receiving sections 568A, 568B. Light is shone at the media S from the light-emitting sections 566A, 566B and light reflected by the media S is received by the light-receiving sections 568A, 568B. By so doing, detection is carried out to determine whether media S are present in the vicinity of the paper guides 9A, 9B.

Thus, providing optical sensors 564A, 564B respectively for the two slidable paper guides 9A, 9B makes it possible to easily check whether or not the media S are properly loaded between the two paper guides 9A, 9B.

It should be noted that while respective optical sensors 564A, 564B are provided here for the two paper guides 9A, 9B, it is not necessary to provide respective optical sensors 564A, 564B for both paper guides 9A, 9B in the above-described manner. In other words, an optical sensor 564A, 564B may be provided for at least one of the two paper guides 9A, 9B.

Position Sensor <1>

<Overview of the Position Sensor>

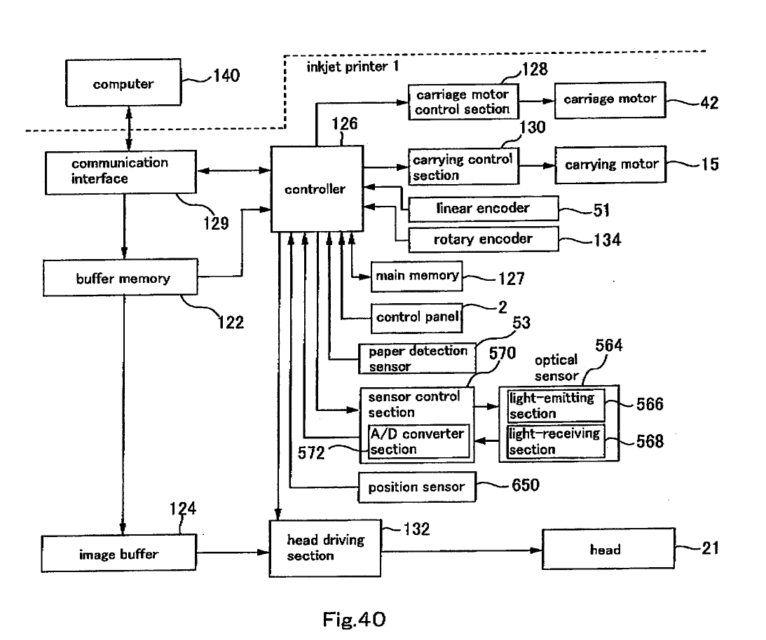

As shown in FIG. 40, the inkjet printer 1 of this embodiment may be provided with a position sensor 650 used for detecting the current position of the paper guide 9. If the printer is provided with such a position sensor 650, then, after checking for presence of media S in the vicinity of the paper guide 9 using the optical sensor 564, the lateral width dimensions of the media S loaded into the paper feed tray 8 can be checked by detecting the current position of the paper guide 9 using the position sensor 650.

Here, the position sensor 650 can detect any given position of the paper guide 9 with respect to the paper feed tray S. The position sensor 650 is provided, for instance, in the rear side portion etc. of the paper feed tray 8. As shown in FIG. 40, the detection results of the position sensor 650 are transmitted to the controller 126. Namely, a detection signal corresponding to the position of the paper guide 9 is outputted from the position sensor 650 to the controller 126. The controller 126 acquires information on the current position of the paper guide 9 based on the detection signal received from the position sensor 650.

<Configuration of the Sensor (1)>

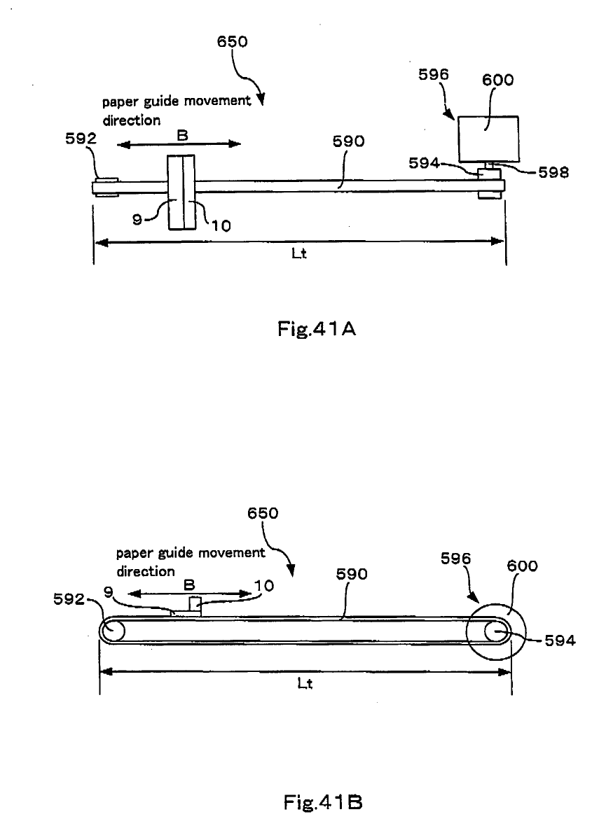

FIG. 41A and FIG. 41B show a simplified illustration of an exemplary S configuration of the position sensor 650 provided in the inkjet printer 1 of this embodiment. FIG. 41 is a plan view explaining the configuration of the position sensor 650 and FIG. 41B is a side view explaining the configuration of the position sensor 650.

As shown in FIG. 41A and FIG. 41B, the position sensor 650 is provided with an endless belt 590 integrally joined to the paper guide 9, a pulley 592 provided at one reach of the endless belt 590, and a rotary variable resistor 596 provided at the other reach of the endless belt 590 via a pulley 594. The endless belt 590 is provided along the direction of movement of the paper guide 9. Its length lit is set in accordance with the moving range of the paper guide 9. In addition, the endless belt 590 is suspended between the two pulleys 592, 594.

On the other hand, the rotary variable resistor 596 is provided with a rotary shaft 598 provided integrally with the pulley 594 and a variable resistor main body 600, which is used to detect the amount of rotation of the rotary shaft 598.

When the endless belt 590 rotates as a result of the movement of the paper guide 9, the rotary shaft 598 is rotated via the pulley 594. The resistance value of the variable resistor main body 600 varies depending on the amount of rotation of the rotary shaft 598. Namely, for instance, when the paper guide 9 moves to the left, the resistance value increases, and when the paper guide 9 moves in the opposite direction, i.e. to the right, the resistance value decreases. As a result, the current location of the paper guide 9 can be acquired based on the current resistance value of the variable resistor main body 600.

Information on the resistance value of the variable resistor main body 600 is transmitted to the controller 126. The controller 126 detects the current position of the paper guide 9 based on the information on the resistance value of the variable resistor main body 600.

<Configuration of the Sensor (2)>

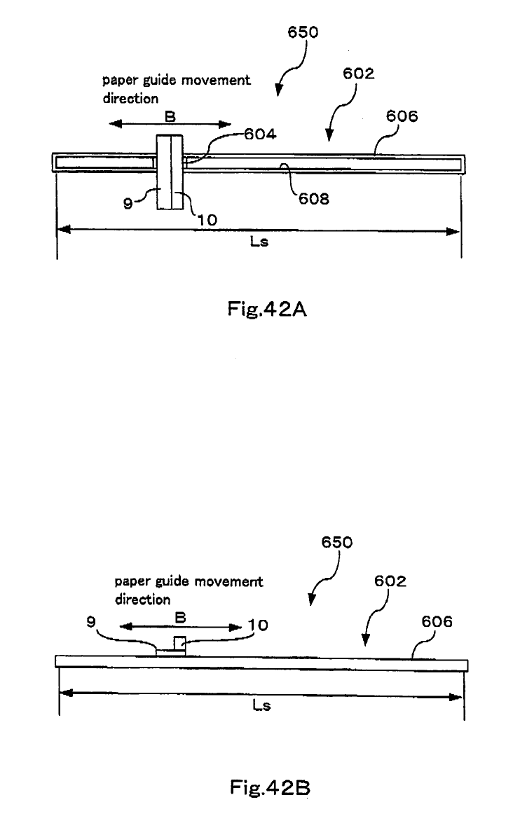

FIG. 42A and FIG. 42B explains a configuration used when a different variable resistor is utilized in the position sensor 650 provided in the inkjet printer 1 of this embodiment. FIG. 42A is a plan view explaining the configuration of the position sensor 650 and FIG. 42B is a side vies explaining the configuration of the position sensor 650.

As shown in FIG. 42A and FIG. 42B, the variable resistor provided in the position sensor 650 is a sliding variable resistor 602. Here, the sliding variable resistor 602 is provided with a sliding block 604 integrally joined to the paper guide 9 and a variable resistor main body 606 capable of detecting the amount of movement of the sliding block 604.

The variable resistor 606 is provided along the direction of movement of the paper guide 9. As shown in FIG. 42A, a guiding groove 608 used for guiding the sliding block 604 is provided in the variable resistor main body 606. The guiding groove 608 is formed along the direction of movement of the paper guide 9 and its length Ls is set in accordance with the moving range of the paper guide 9. When the paper guide 9 moves, the sliding block 604 moves relatively along the guiding groove 608.

On the other hand, when the sliding block 604 moves along the guiding groove 608, the resistance value of the variable resistor main body 606 changes depending on the amount of movement. Namely, for instance, when the paper guide 9 moves to the left, the resistance value increases, and, when the paper guide 9 moves in the opposite direction, i.e. to the right, the resistance value decreases. As a result, the current location of the paper guide 9 can be acquired based on the current resistance value of the variable resistor main body 606.

Information on the resistance value of the variable resistor main body 606 is transmitted to the controller 126. The controller 126 detects the current position of the paper guide 9 based on the information on the resistance value of the variable resistor main body 606.

Position Sensor <2>

<Overview of the Sensor>

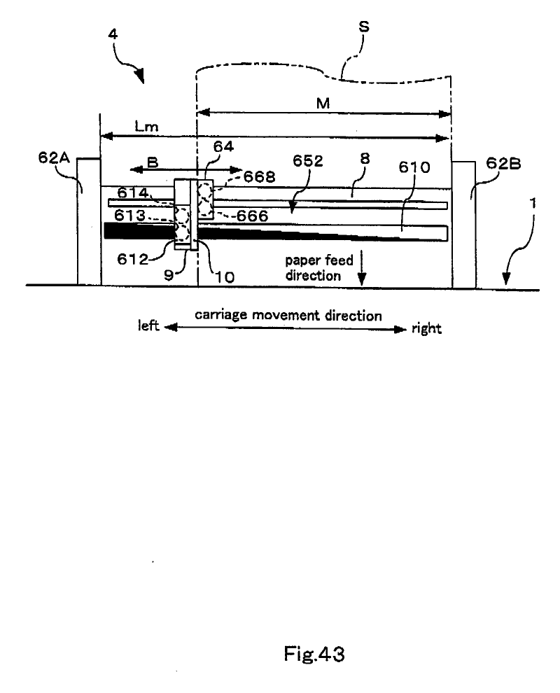

FIG. 43 explains another exemplary configuration of the position sensor. As shown in the same diagram, the position sensor 652 is provided with a position detection pattern 610 and an optical sensor 612, which reads the position detection pattern 610. The position detection pattern 610 is provided on the side of the paper feed tray 8 in order for the position of the paper guide 9 to be detected. The position detection pattern 610 is formed on the top face of the paper feed tray 8 in the shape of a strip in the direction of movement of the paper guide 9, i.e. in the direction of movement of the carriage 41. The position detection pattern 610 is printed on a sheet or a piece of adhesive tape, etc. and attached to the paper feed tray 8 by adhesion, etc.

On the other hand, the optical sensor 612, as shown in the same diagram, is provided on the paper guide 9. The optical sensor 612 is provided facing the position detection pattern 610 and above the position detection pattern 610 provided on the paper feed tray 8. When the paper guide 9 moves, the optical sensor 612 relatively moves in tandem with the paper guide 9 along the position detection pattern 610 and above the position detection pattern 610.

<Configuration of the Optical Sensor>

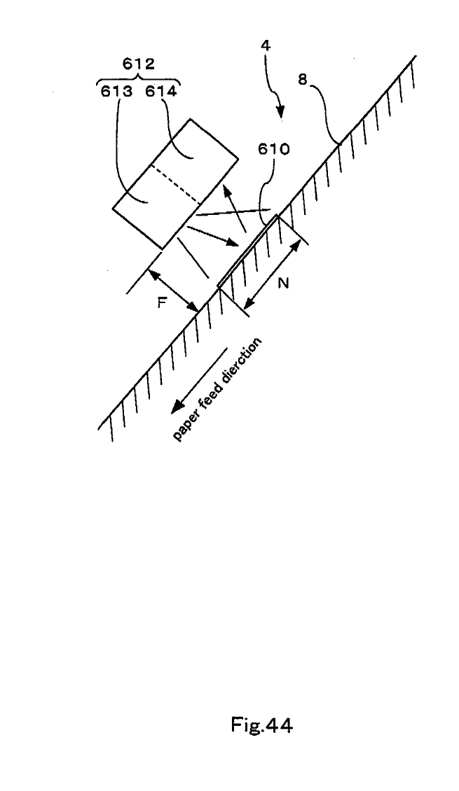

FIG. 44 explains the configuration of the optical sensor 612 in detail. The optical sensor 612 is a reflective optical sensor and, as shown in the same diagram, it is provided with a light-emitting section 613, which emits light, and a light-receiving section 614, which receives light. The light-emitting section 613 and light-receiving section 614 are arranged facing the position detection pattern 610 at a predetermined spacing F from the position detection pattern 610. The light-emitting section 613, which is constituted, for instance, by a light-emitting diode etc., emits light toward the position detection pattern 610. On the other hand, the light-receiving section 614, which is constituted e.g. by a phototransistor etc., receives light reflected by the position detection pattern 610.

The spot size of the light emitted by the light-emitting section 613 is set to be either nearly equal to, or greater than, the longitudinal width dimension N of the position detection pattern 610. As a result, light emitted from the light-emitting section 613 illuminates the entire position detection pattern 610 in its longitudinal width direction. Light reflected from the entire position detection pattern 610 in its longitudinal width direction is incident on the light-receiving section 614.

The light-receiving section 614 generates and outputs a signal corresponding to the intensity of the light incident on said light-receiving section 614. That is, for instance, a high-level signal is generated and outputted when the intensity of the light incident on the light-receiving section 614 is high. Also, for instance, a low-level signal is generated and outputted when the intensity of the light incident on the light-receiving section 614 is low.

The signal generated by the light-receiving section 614 is outputted outside from the optical sensor 612 as a detection signal. In this embodiment, the signal generated by the light-receiving section 614 of the optical sensor 612 is outputted to the controller 126.

<Position Detection Pattern>

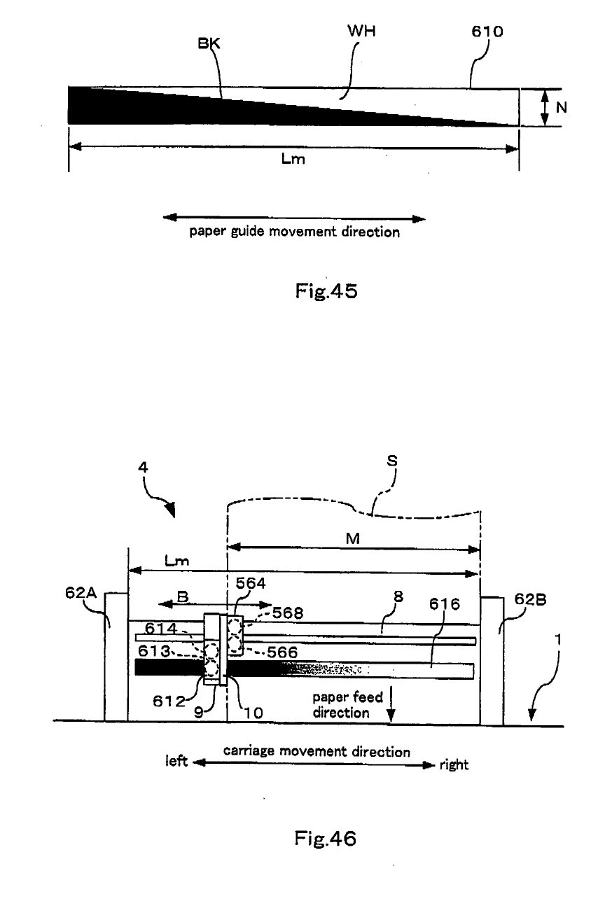

The position detection pattern 610 is described below. FIG. 45 illustrates the position detection pattern 610 in detail. As shown in the same diagram, the position detection pattern 610 of this embodiment has two regions of different colors, i.e. a white region WH formed in the shape of a right triangle and a black region BK similarly formed in the shape of a right triangle. The right triangle-shaped white region WH and black region BK have their hypotenuses mutually joined such that these two right triangle-shaped regions WH and BK form an elongated position detection pattern 610 shaped like a rectangle.

The white region WH is provided such that it tapers off on the left side of the position detection pattern 610. In addition, the black region BK is provided such that it tapers off on the right side of the position detection pattern 610. As a result, the proportion of the white region WH to the black region BK varies in the direction of movement of the paper guide 9. That is, the proportion of the black region BK becomes larger than the proportion of the white region WH in the left portion of the position detection pattern 610. In addition, the proportion of the white region WH becomes larger than the proportion of the black region BK in the right portion of the position detection pattern 610.

In this manner, the proportion of the white region WH to the black region BK varies depending on the position along the position detection pattern 610, thereby causing variation in the reflectance of the light emitted from the light-emitting section 613. That is, the reflectance of light becomes lower in the right portion of the position detection pattern 610, where the proportion of the white region WH is larger than the proportion of the black region BK. Also, the reflectance of light becomes higher in the right portion of the position detection pattern 610, where the proportion of the white region WH is larger than the proportion of the black region BK. In other words, the reflectance of light emitted from the light-emitting section 613 gradually decreases in the direction of movement of the paper guide 9 from the right portion of the position detection pattern 610 to its left portion.

In this manner, by varying the reflectance of light emitted from the light-emitting section 613 depending on the position along the position detection pattern 610, it becomes possible to detect the current position of the paper guide 9. That is, since the intensity of the reflected light varies depending on the position along the position detection pattern 610, the position of the paper guide 9 can be detected by determining the intensity of the reflected light.

In particular, any given position of the paper guide 9 with respect to the paper feed tray 8 can be detected because the proportion of the white region WH to the black region BK in the position detection pattern 610 of this embodiment gradually changes in the direction of movement of the paper guide 9.

In addition, since the length Lm of the position detection pattern 610 is set in accordance with the moving range of the paper guide 9, the position of the paper guide 9 can be detected regardless of where it is located.

<Processing Executed by the Controller>

The controller 126 detects the current position of the paper guide 9 based on the signal outputted from the optical sensor 612. That is, here, the controller 126 determines that as the intensity of the light received by the light-receiving section 614 grows stronger, the paper guide 9 moves to the right side of the paper teed tray 8. On the other hand, the controller 126 determines that as the intensity of the light received by the light-receiving section 614 becomes weaker, the paper guide 9 moves to the left side of the paper feed tray 8.

As a result, the controller 126 can detect the current position of the paper guide 9. Moreover, the controller 126 can detect any given position of the paper guide 9 because, as shown in FIG. 45, the reflectance of the light emitted by the light-emitting section 613 of the optical sensor 612 varies from the right side of the position detection pattern 610 to its left side. It should be noted that the controller 126 of this embodiment corresponds to the “detection section”.

<Another Position Detection Pattern (1)>

FIG. 46 explains an example of another type of position detection pattern 616. As shown in the same diagram, the position detection pattern 616 used here is a pattern, in which the darkness of color varies in the direction of movement B of the paper guide 9. Here, black color darkness varies in the direction of movement B of the paper guide 9. In addition, the darkness of color is set so as to gradually increase from the right edge to the left edge of the position detection pattern 616. That is, black color darkness becomes lighter at the right edge of the position detection pattern 616, producing a near-white color. Also, black color darkness becomes darker at the left edge of the position detection pattern 616, producing a near-black color. The gray color becomes gradually darker from the right edge to the left edge of the position detection pattern 616.

In this manner, the darkness of color varies depending on the position along the position detection pattern 616 in the direction of movement of the paper guide 9, thereby causing variation in the reflectance of the light emitted from the light-emitting section 613. In other words, here, the reflectance of light is lower at the right edge of the position detection pattern 616, where black color darkness is lower, and, on the other hand, the reflectance of light becomes higher at the left edge of the position detection pattern 616, where black color darkness is higher.

In this manner, by varying the reflectance of light emitted from the light-emitting section 613 depending on the position along the position detection pattern 616, it becomes possible to detect the current position of the paper guide 9. In particular, any given position of the paper guide 9 with respect to the paper feed tray 8 can be detected because the darkness of color in the position detection pattern 616 gradually changes in the direction of movement of the paper guide 9.

It should be noted that in this case, the spot size of the light-emitting section 613 of the optical sensor 612 does not need to be set to be either nearly equal to, or greater than, the width dimension N of the position detection pattern 616, as was done in the above-described embodiment. In other words, here, the reflectance of light varies as a result of color darkness variation, and therefore the difference in light reflectance depending on the position along the position detection pattern 616 can be detected regardless of where the light-emitting section 613 emits light on the position detection pattern 616. With such a position detection pattern 616, it is possible to detect any given position of the paper guide 9.

Relationship Between Size and Lateral Width Dimensions of Media

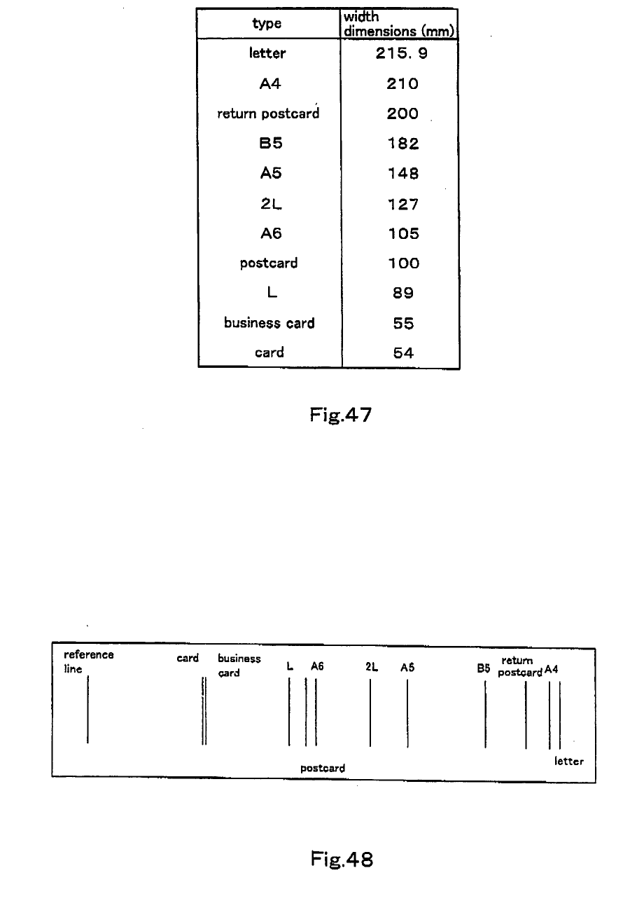

FIG. 47 specifically illustrates various standard sizes of media and their lateral width dimensions. FIG. 48 specifically illustrates the relationship of the lateral width dimensions of media S. Here, the medium of the largest size is “letter”. Starting from the “letter” size, the lateral width dimensions become successively smaller in the following order: “A4”, “return postcard”, “B5”, “A5”, “2L”, “A6”, “Postcard”, “L”, “business card”, and “card”. Thus, the type of the media S can be distinguished by detecting the lateral width dimensions, because the lateral width dimensions vary depending on the type of the media S.

Moreover, in the inkjet printer 1 of this embodiment, the position sensors 650, 652 are capable of detecting any given position of the paper guide 9. Accordingly, it is possible to accurately detect the position of the paper guide 9 and allow for the type of the media S to be distinguished relatively easily even in case of media whose lateral width dimensions are not particularly different, such as, for instance, “letter” and “A4”, “A4” and “post-card”, “A6” and “post-card”, “business card” and “card”.

In addition, processing for distinguishing the type of the media S based on the detection results received from the position sensors 650, 652 can be carried out by the controller 126 of the inkjet printer 1 or by the externally connected computer 140.

<Another Position Detection Pattern (2)>

The following patterns can be provided as position detection patterns in the position sensor 152 for distinguishing between media S, whose lateral width dimensions are not significantly different, such as “letter” and “A4”, “A4” and “postcard”, “A6” and “postcard”, “business card”, and “card”, etc.

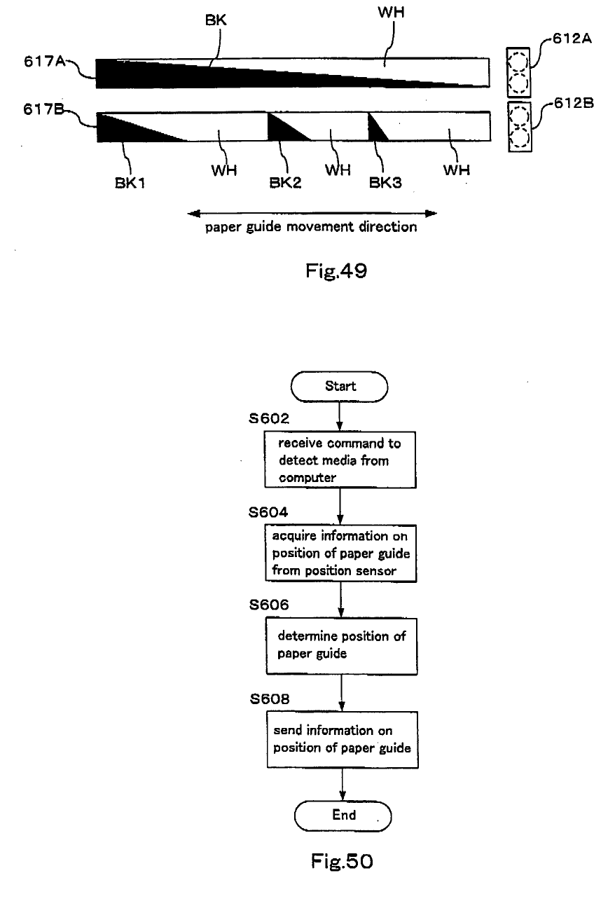

FIG. 49 illustrates an example of such position detection patterns. A first pattern 617A, which has a single right triangle-shaped black region BK, and a second pattern 617B, which has a plurality of right triangle-shaped black regions BK1, BK2, and BK3, are provided here as position detection patterns. Here, the first pattern 617A has a black region BK formed in the shape of a right triangle and a white region WH similarly formed in the shape of a right triangle. The two regions BK, WH have their hypotenuses mutually joined to form the first pattern 617A in the shape of an elongated rectangle.

On the other hand, here, the second pattern 617B has three right triangle-shaped black regions BK1, BK2, and BK3. The black regions BK1, BK2, and BK3 are arranged such that they are mutually separated by spacing apart along the direction of movement of the paper guide 9. Furthermore, in this embodiment, the black regions BK1, BK2, and BK3 vary in size. Here, the size of the black region BK1 is largest, followed by the black region BK2 and then the black region BK3. The black regions BK1, BK2, and BK3 are provided in order for the position of the paper guide 9 to be detected with a higher degree of accuracy.

Namely, since only one right triangle-shaped black region BK is provided in the first pattern 617A, when the position of the paper guide 9 is detected based on the first pattern 617A alone, accurate detection of the lateral width dimensions of the media S may not be possible and it may be difficult to accurately identify the type of the media S in case of media S whose lateral dimensions are not significantly different. Consequently, the position is detected using the second pattern 617B in conjunction with the first pattern 617A.

In order to be able to more accurately distinguish the type of media S whose respective lateral width dimensions are not significantly different, the three black regions BK1, BK2, and BK3 of the second pattern 617B are respectively provided in the vicinity of locations corresponding to the lateral width dimensions of such media S. For instance, the black region BK1 is provided for the purpose of more accurately distinguishing between “letter”, “A4”, and “return postcard”. Also, the black region BK2 is provided for the purpose of more accurately distinguishing between “A6”, “postcard”, and “L”. In addition, the black region BK3 is provided for the purpose of more accurately distinguishing between “business card” and “card”. Providing these three black regions BK1, BK2, and BK3 makes it possible to distinguish the type of the media S having extremely similar lateral width dimensions with a higher degree of accuracy.

It should be noted that here the two optical sensors 612A, 612B are provided integrally with the paper guide 9 for the purpose of performing detection individually for the first pattern 617A and the second pattern 617B.

Additionally, although the explanations provided herein refer to the first pattern 617A and second pattern 617B having right triangle-shaped black regions BK, BK1, BK2, and BK3, instead of the first pattern 617A and second pattern 617B, patterns can be provided in which color darkness varies in the direction of movement of the paper guide 9, such as the one explained in FIG. 46.

Processing Executed by the Controller

When a command to detect the position of the paper guide 9 is received from the external computer 140, the controller 126 acquires information on the current position of the paper guide 9 from the position sensors 650, 652. The controller 126 then transmits the acquired information on the current position of the paper guide 9 to the computer 140.

FIG. 50 is a flowchart explaining an example of processing used by the controller 126 to detect the position of the paper guide 9. Here, first of all, the controller 126 acquires a command to detect the position of the paper guide 9 from the external computer 140 (S602). When such a command is received from the computer 140, the controller 126 acquires information on the current position of the paper guide 9 from the position sensors 650, 652 (S604). The controller 126 then performs processing to determine the current position of the paper guide 9 by calculation, etc, based on the acquired information on the current position of the paper guide 9 (S606). After determining the current position of the paper guide 9 in this manner, the controller 126 sends the resultant information on the current position of the paper guide 9 to the external computer 140 (S608).

Computer Processing (2)

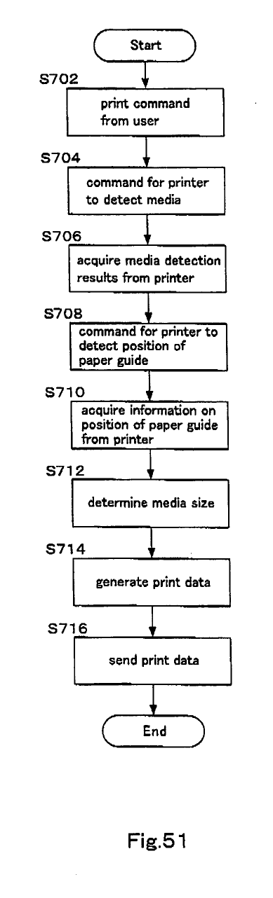

FIG. 51 explains an exemplary processing procedure used by the computer when it performs processing both for detecting the media S and for detecting the position of the paper guide 9.

When a print command is issued by the user (S702), the computer 140 issues a command for the inkjet printer 1 to check whether or not media S are present in the vicinity of the paper guide (S704). When the computer 140 issues the command, the controller 126 of the inkjet printer 1 uses the optical sensor 564 to check for presence of the media S. The controller 126 then transmits the results of the check to the computer 140.

After receiving the results of the check from the inkjet printer 1, the computer 140 issues a command for the inkjet printer 1 to detect the position of the paper guide 9 (S708). It should be noted that, here, if no media S have been detected by the optical sensor 564, the computer assumes that possibly either the paper guide 9 is not positioned in close proximity to the edge of the media S or the media S to be printed have not been loaded into the paper feed tray 8 and informs the user accordingly by displaying a message, etc.

When the command to detect the position of the paper guide 9 is received from the computer 140, the controller 126 acquires information on the current position of the paper guide 9 from the position sensors 650, 652. The controller 126 then transmits the acquired information on the current position of the paper guide 9 to the computer 140.

The computer 140 receives information on the current position of the paper guide 9 from the inkjet printer 1 (S710). The computer 140 then determines the size of the media S to be printed based on the acquired information (S712). Here, the computer 140 determines whether the size is “size A4”, “size B5”, “postcard size”, etc.

The computer 140 then generates print data based on the size of the media S obtained as a result of such determination (S714). Here, the computer 140 acquires information on the size of the media S actually loaded into the paper feed tray 8 from the information on the current position of the paper guide 9 supplied from the inkjet printer 1 and, based on this information, generates print data that permits images be printed so as to match the size of the media S to be printed upon. The computer 140 sends the generated print data to the inkjet printer 1 (S716).

Configuration of the Printing System etc.

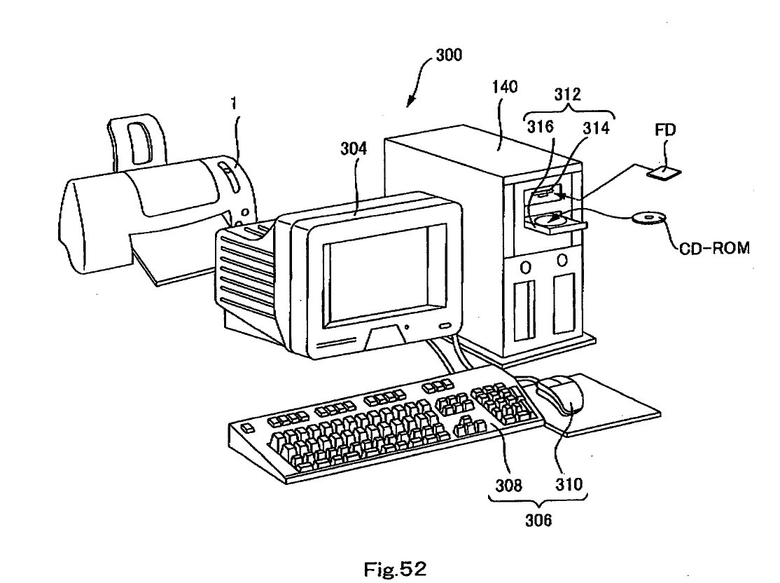

Next, explanations are given regarding an embodiment of a printing system, in which the inkjet printer 1 is provided as a printing apparatus. FIG. 52 is an external configuration view of an embodiment of such a printing system. The printing system 300 is provided with a computer 140, a display device 304, and an input device 306. The computer 140 is constituted by any of the various types of computers, primarily such as PCs and the like.

The computer 140 is provided with reading devices 312, such as a FD drive device 314, a CD-ROM drive device 316, etc. In addition, the computer 140 may be equipped, for instance, with an MO (Mageto-optical) disk drive device or a DVD drive device, etc. In addition, the display device 304 is constituted by any of the various display devices such as a CRT display, a plasma display, a liquid crystal display, etc. The input device 306 is constituted by a keyboard 308, a mouse 310, etc.

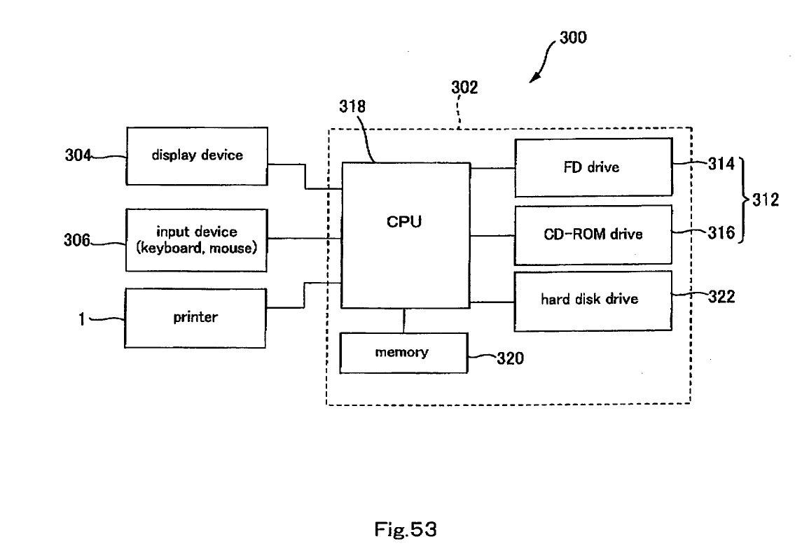

FIG. 53 is block diagram illustrating an exemplary system configuration of the printing system of this embodiment. In addition to the reading devices 312, such as a ED drive device 314, a CD-ROM drive device 316, etc., the computer 140 is provided with a CPU 318, a memory 320, and a hard disk drive 322.

The CPU 318 exercises overall control over the computer 140. In addition, various data is stored in the memory 320. Printer drivers and the like are installed on the hard disk drive 322 as programs used for controlling the printing apparatus of this embodiment, such as an inkjet printer 1, etc. The CPU 318 reads the printer drivers and other programs stored on the hard disk drive 322 and operates in accordance with the programs. In addition, the display device 304, the input device 306, the inkjet printer 1, and other devices installed outside the computer 140 are connected to the CPU 318.

It should be noted that the thus realized printing system 300, on the whole, is superior to conventional systems.

### Other Embodiments

Explanations regarding a printing apparatus, such as a printer, were provided above using an embodiment, but the above-described embodiment, however, was used solely for the purpose of facilitating the understanding of the invention and should not be construed to limit the present invention. The present invention can of course be altered or improved without departing from the gist thereof, and includes equivalents. In particular, the embodiments described below are also within the scope of the inventive printing apparatus.

In addition, in this embodiment, configurations realized through hardware can be, partly or entirely, replaced with software, and conversely, configurations realized through software can be, partly, replaced with hardware.

In addition, some of the processing performed by the printing apparatus (inkjet printer 1, etc.) may be carried out by the computer 140, or a special processing device may be installed between the printing apparatus (inkjet printer 1, etc.) and the computer 140 in order to perform some of the processing in this processing device.

<Regarding the Paper Feed Section>

In the above-described embodiment, a paper feed tray 8, in which media S were loaded at an angle in the rear portion of the printing apparatus (inkjet printer 1) was used as an example of the paper feed section, but the paper feed section is not limited to paper feed sections such as the paper feed tray 8. In other words, it may be a paper feed section provided with a paper feed tray, in which media S are loaded not at an angle, but horizontally. In addition, paper feed cassettes detachably installed in printing apparatuses also fall under the category of paper feed sections. In addition, regardless of the nature of the locations where media S to be printed upon are loaded, all such locations fall under the category of paper feed sections.

<Regarding the Regulating Guide>

In the above-described embodiments, rectangular-shaped paper guides 9 having a tab section 10, such as the ones shown in FIG. 1, FIG. 6, FIG. 12, FIG. 13, FIG. 17, FIG. 18, FIG. 20, FIG. 23, FIG. 27, FIG. 33, FIG. 38, FIG. 39, FIG. 43, and FIG. 46, were used as examples of the regulating guide; however, the regulating guide is not limited to this type of paper guides 9. In other words, regulating guides of any type and shape can be used so long as the guides are installed in such a manner that they can move relative to the paper feed tray 8 to regulate the positional shifting of the media S in close proximity to the edge of the media S loaded into the paper feed tray 8.

<Regarding the Variable Resistor>

Variable resistors disclosed in the above-described embodiments included rotary variable resistors 76, 596 and sliding variable resistors 82, 602, but variable resistors are not limited to these variable resistors 76, 82, 596, and 602, and any resistor may be used so long as these resistors have resistance values varying depending on the given position of the regulating guide (paper guide 9) with respect to the paper feed section.

<Regarding the Position Sensor>

Although in the above-described embodiments, position sensors were specifically exemplified by position sensors 150, 650 provided with variable resistors such as rotary variable resistors 76, 596 and sliding variable resistors 82, 602, etc., as well as by position sensors 152, 652 provided with position detection patterns 90, 92, 610, 616 and optical sensors 100, 612, they are not limited to such position sensors. In other words, the position sensors can be any sensors so long as these sensors are capable of detecting any given position of the regulating guide (paper guide 9) with respect to the paper feed tray 8.

<Regarding the Optical Sensor (1)>

Although optical sensors disclosed in the above-described embodiments included optical sensor 100, in which light-emitting sections 102, 482, 613 and light-receiving sections 104, 484, 614 are arranged in the paper feed direction, as in the ones shown in FIG. 13, FIG. 14, FIG. 17, FIG. 19, FIG. 20, FIG. 21, FIG. 23, FIG. 43, FIG. 44, and FIG. 46, optical sensors are not necessarily constructed in this manner. That is, any type of optical sensor can be used so long as the sensor is provided with a light-emitting section emitting light toward a position detection pattern provided on the side of the paper feed section and a light-receiving section receiving light reflected by the position detection pattern.

<Regarding the Position Detection Pattern>

Although examples of position detection patterns provided in the above-described embodiments included position detection patterns 90, 470, 610, which had at least two regions of different colors and in which the proportion of the regions of different colors varied in the direction of movement of the regulating guide (paper guide 9), as well as position detection patterns 92, 472, 616, in which color darkness varied in the direction of movement of the regulating guide (paper guide 9), position detection patterns are not limited to these patterns. In other words, these may be any patterns so long as the patterns are used for detecting the position of the regulating guide (paper guide 9) with respect to the paper feed section.

In addition, while methods of forming position detection patterns 90, 92, 470, 472, 610, 616 on the paper feed tray 8 disclosed in the above-described embodiments included printing them on a sheet or a piece of adhesive tape etc. and attaching to the paper feed tray 8 by adhesion etc., methods of providing position detection patterns on the side of the paper feed section are not limited to such methods. In other words, position detection patterns do not need to be provided on the paper feed tray 8 and, in addition, they are not necessarily provided by adhesion etc. For instance, patterns may be formed on the surface of the paper feed tray 8 directly by coating or painting and, in addition, patterns with light reflectance varying in the direction of movement of the regulating guide (paper guide 9) may be produced by forming textured surfaces by mechanical treatment. In addition, in view of the fact that the reflectance of light emitted from the optical sensors 100, 400 varies depending on the distance between the optical sensors 100, 400 and the reflecting section, the position detection patterns may be formed by providing convex and concave portions on the paper feed tray 8.

In addition, although examples of position detection patterns of varying reflectance included position detection patterns 90, 470, 610, which had at least two regions of different colors and in which the proportion of the regions of different colors varied in the direction of movement of the regulating guide (paper guide 9), as well as position detection patterns 92, 472, 616, in which color darkness varied in the direction of movement of the regulating guide (paper guide 9), position detection patterns are not limited to patterns 90, 92, 470, 472, 610, and 616. In other words, these may be any patterns so long as the patterns exhibit light reflectances varying in the direction of movement of the regulating guide (paper guide 9).

<Color of the Position Detection Pattern >

Colors used for the position detection patterns 90, 92, 470, 472, 610, and 616 in the above-described embodiments included the black and white colors, but position detection patterns are not limited to these colors. In other words, for instance, various colors may be used, in other words, for instance, blue, yellow, red, green, etc.

In addition, the base color of the paper feed tray 8 etc. can be used as one of the colors forming the position detection pattern 90, 92, 470, 472, 610, and 616. That is, for instance, in case of the position detection patterns described in FIG. 6, FIG. 8, FIG. 20, FIG. 22, FIG. 43, and FIG. 45, the right triangle-shaped black regions BK or white regions WH may be formed using the base color of the paper feed tray 8. In other words, only one region among the black region BK and white region WE will be formed by printing or sealing.

<Regarding the Detection Section>

In the above-described embodiments, the detection section was implemented via detection of the position of the regulating guide (paper guide 9) by the controller 126 of the printing apparatus (inkjet printer 1) based on signals outputted from the optical sensor, but the detection section is not limited to such cases. Namely, the detection section may be implemented by providing a dedicated processing device etc. used for detecting the position of the regulating guide based on signals outputted from the optical sensor. In addition, the detection section may be provided outside the inkjet printer 1.

<Regarding Other Regulating Guides>

Although in the above-described embodiments examples of other regulating guides included the protruding section 62B provided along the right side of the paper feed section, i.e. a paper feed tray 8, as illustrated in FIG. 6, and the paper guide 9B provided movably relative to the paper feed section, as illustrated in FIG. 13, the other regulating guides are not limited thereto.

<Regarding Sensors for Detecting Presence of Media>

Although examples of sensors used for detecting the presence of media in the above-described embodiments included a case in which an optical sensor with a light-emitting section emitting light and a light-receiving section receiving light was used, the sensors are not limited to the above-described optical sensor. In other words, this may be any type of sensor so long as the sensor detects the presence of media S within a predetermined distance from the regulating guide (paper guide 9, etc.). The sensors may be sensors capable of detecting the presence of media S using various techniques, for instance, such as contact-type sensors with levers etc. for detecting the presence of media via contact with the media.

<regarding the Optical Sensor (2)>

Although optical sensors for detecting the presence of media S disclosed in the above-described embodiments included optical sensors 564, 580, in which light-emitting sections 566, 582 and light-receiving sections 568, 584 were arranged in the paper feed direction, as shown in FIG. 32, FIG. 33, FIG. 34, FIG. 38, and FIG. 39, the optical sensors are not necessarily constructed in this manner. That is, this may be any type of optical sensor so long as it is provided with a light-emitting section emitting light and a light-receiving section receiving light for the purpose of detecting the presence of media S loaded into the paper feed tray 8.

<Regarding the Predetermined Distance>

In the above-described embodiments, the distance from the regulating guide used as a criterion for detecting the presence of media was a certain distance away from said regulating guide (paper guide 9), such as, for instance, not less than 1 mm and not more than 10 mm or so, but the predetermined distance serving as a criterion for detecting the presence of media may be set to a longer distance from the regulating guide (paper guide 9), for instance, to 3 mm etc.

<Regarding the Printing Apparatus>

In the above-described embodiments, the above-described inkjet printer 1 was used as an example of the printing apparatus, but the latter, however, is not limited thereto and any apparatus may be considered a printing apparatus so long as the apparatus is furnished with printing functionality, such as, of course, inkjet printers that eject ink in other ways, and, in addition, printers that do not eject ink, such as dot-matrix printers, thermal transfer printers, laser printers, etc.

<Regarding the Media>

The media S may be plain paper, matte paper, pre-cut paper, glossy paper, paper in rolls, special purpose paper, photographic paper, photographic paper in rolls, etc., and, in addition to the above, OHP film, glossy film and other types of film materials and fabric materials, metal plates, etc. In other words, these may be any media so long as they can be printed upon.

What is claimed is:

1. A printing apparatus comprising:
a paper feed section into which a medium to be printed is loaded;
a regulating guide provided movably relative to said paper feed section for regulating positional shifting of said medium in close proximity to an edge of said medium loaded into said paper feed section; and
a position sensor capable of detecting any given position of said regulating guide with respect to said paper feed section.

2. A printing apparatus according to claim 1, wherein
said position sensor has a variable resistor whose resistance value varies depending on the position of said regulating guide with respect to said paper feed section.

3. A printing apparatus according to claim 2, wherein
said variable resistor is a rotary variable resistor or a sliding variable resistor.

4. A printing apparatus according to claim 1, wherein,
in order to detect the position of said regulating guide with respect to said paper feed section, said position sensor has
a position detection pattern provided on the paper feed section side,
an optical sensor that is provided on the regulating guide side, that has a light-emitting section emitting light toward said position detection pattern and a light-receiving section receiving light reflected from said position detection pattern, and that outputs a signal corresponding to the intensity of the light received by said light-receiving section, and
a detection section for detecting the position of said regulating guide with respect to said paper feed section based on said signal outputted from said optical sensor.

5. A printing apparatus according to claim 4, wherein
said position detection pattern is a pattern in which the reflectance of light emitted from said light-emitting section varies in a direction of movement of said regulating guide.

6. A printing apparatus according to claim 5, wherein
said pattern in which the reflectance of light varies is a pattern having at least two or more regions of different colors, with the proportion between the regions of different colors varying in the direction of movement of said regulating guide.

7. A printing apparatus according to claim 5, wherein
said pattern in which the reflectance of light varies is a pattern in which the darkness of color varies in the direction of movement of said regulating guide.

8. A printing apparatus according to claim 1, wherein
another regulating guide is provided in order to regulate positional shifting of said medium in close proximity to an edge of said medium from the side opposite from said regulating guide.

9. A printing apparatus according to claim 1, wherein
the detection of said any given position of said regulating guide by said position sensor is carried out when performing printing on said medium.

10. A printing method comprising;
a step of detecting, using a position sensor, any given position of a regulating guide with respect to a paper feed section, said regulating guide being provided movably relative to said paper feed section in order to regulate positional shifting of a medium in close proximity to an edge of said medium that has been loaded into said paper feed section; and
a step of performing printing on said medium.

11. A printing apparatus comprising:
a paper feed section into which a medium to be printed is loaded;
a regulating guide provided movably relative to said paper feed section for regulating positional shifting of said medium in close proximity to an edge of said medium loaded into said paper feed section;
a position detection pattern provided on the paper feed section side in order for the position of said regulating guide, with respect to said paper feed section, to be detected;
an optical sensor that is provided on the regulating guide side, that has a light-emitting section emitting light toward said position detection pattern and a light-receiving section receiving light reflected from said position detection pattern, and that outputs a signal corresponding to the intensity of the light received by said light-receiving section; and
a detection section for detecting the position of said regulating guide with respect to said paper feed section based on said signal outputted from said optical sensor.

12. A printing apparatus according to claim 11, wherein
said position detection pattern is provided along a direction of movement of said regulating guide.

13. A printing apparatus according to claim 11, wherein
said position detection pattern is a pattern in which the reflectance of light emitted from said light-emitting section varies in the direction of movement of said regulating guide.

14. A printing apparatus according to claim 13, wherein
said pattern in which the reflectance of light varies is a pattern having at least two or more regions of different colors, with the proportion between the regions of different colors varying in the direction of movement of said regulating guide.

15. A printing apparatus according to claim 13, wherein
said pattern in which the reflectance of light varies is a pattern in which the darkness of color varies in the direction of movement of said regulating guide.

16. A printing apparatus according to claim 11, wherein
said position detection pattern is made of a plurality of patterns, each pattern having a different reflectance of light emitted from said light-emitting section.

17. A printing apparatus according to claim 16, wherein
each of said plurality of patterns having different light reflectances has a different darkness in color.

18. A printing apparatus according to claim 16, wherein
each of said plurality of patterns having different light reflectances has at least two or more regions of different colors, with the proportion between the regions of different colors varying for each pattern.

19. A printing apparatus according to claim 16, wherein
said plurality of patterns having different light reflectances are provided in positions respectively corresponding to standard sizes of said medium.

20. A printing apparatus according to claim 11, comprising
another regulating guide in order to regulate positional shifting of said medium in close proximity to an edge of said medium from the side opposite from said regulating guide.

21. A printing apparatus according to claim 11, wherein
the detection of said position of said regulating guide by said optical sensor is carried out when performing printing on said medium.

22. A printing method comprising:
a step of detecting a position, with respect to a paper feed section, of a regulating guide that is provided movably relative to said paper feed section in order to regulate positional shifting of a medium in close proximity to an edge of said medium that has been loaded into said paper feed section, using
a position detection pattern provided on the paper feed section side, and
an optical sensor that has a light-emitting section and a light-receiving section and, by emitting light toward said position detection pattern from said light-emitting section and receiving light reflected from said position detection pattern with said light-receiving section, outputs a signal corresponding to the intensity of the light received by said light-receiving section; and
a step of performing printing on said medium.

23. A printing apparatus comprising:
a paper feed section into which a medium to be printed is loaded;
a regulating guide provided on said paper feed section for regulating positional shifting of said medium in close proximity to an edge of said medium loaded into said paper feed section; and
a sensor that detects whether or not said medium is present within a predetermined distance from said regulating guide.

24. A printing apparatus according to claim 23, wherein
said sensor is an optical sensor having a light-emitting section that emits light and a light-receiving section that receives light.

25. A printing apparatus according to claim 23, wherein
said sensor is provided on said regulating guide.

26. A printing apparatus according to claim 23, wherein
said predetermined distance is set to not less than 1 mm and not more than 10 mm.

27. A printing apparatus according to claim 23, wherein
the detection by said sensor of whether or not said medium is present is carried out when performing printing on said medium.

28. A printing apparatus according to claim 23, wherein
said regulating guide is a fixed guide provided integrally with said paper feed section.

29. A printing apparatus according to claim 23, wherein
said regulating guide is a movable guide provided movably relative to said paper feed section.

30. A printing apparatus according to claim 29, comprising:
a position sensor for detecting the position of said movable guide.

31. A printing apparatus according to claim 30, wherein
said position sensor detects any given position of said movable guide with respect to said paper feed section.

32. A printing apparatus according to claim 30, wherein
said position sensor has a variable resistor whose resistance value varies depending on the position of said movable guide with respect to said paper feed section.

33. A printing apparatus according to claim 30, wherein,
in order to detect the position of said movable guide with respect to said paper feed section, said position sensor has
a position detection pattern provided on the paper feed section side,
an optical sensor that is provided on the movable guide side, that has a light-emitting section emitting light toward said position detection pattern and a light-receiving section receiving light reflected from said position detection pattern, and that outputs a signal corresponding to the intensity of the light received by said light-receiving section, and
a detection section for detecting the position of said movable guide with respect to said paper feed section based on said signal outputted from said optical sensor.

34. A printing apparatus according to claim 33, wherein
said position detection pattern is a pattern in which the reflectance of light emitted from said light-emitting section varies in a direction of movement of said movable guide.

35. A printing apparatus according to claim 34, wherein
said pattern in which the reflectance of light varies is a pattern having at least two or more regions of different colors, with the proportion between the regions of different colors varying in the direction of movement of said movable guide.

36. A printing apparatus according to claim 34, wherein
said pattern in which the reflectance of light varies is a pattern in which the darkness of color varies in the direction of movement of said movable guide.

37. A printing method comprising:
a step of detecting, using a sensor, whether or not a medium is present within a predetermined distance from a regulating guide that is provided on a paper feed section in order to regulate positional shifting of said medium in close proximity to an edge of said medium when performing printing on said medium loaded into said paper feed section; and
a step of performing printing on said medium that has been loaded into said paper feed section.

38. A printing method according to claim 37, wherein
the position of said regulating guide with respect to said paper feed section is detected by a position sensor after detecting whether or not said medium is present within a predetermined distance from said regulating guide.
